(19) United States
(12) Patent Application Publication
(10) Pub. No.: US 2026/0299448 A1
(43) Pub. Date: Oct. 1, 2026

(54) TONER

(71) Applicant: CANON KABUSHIKI KAISHA, Tokyo (JP)

(72) Inventors: SHUHEI IWASAKI, Kanagawa (JP); KENJI AOKI, Shizuoka (JP); KAHO YAMADA, Shizuoka (JP); YUHEI TERUI, Shizuoka (JP); TATSUYA SAEKI, Shizuoka (JP)

(21) Appl. No.: 19/576,274

(22) Filed: Mar. 24, 2026

(30) Foreign Application Priority Data
Mar. 28, 2025 (JP) 2025-055068

(51) Int. Cl. G03G 9/087; C08F 20/10

(52) U.S. Cl. CPC G03G 9/08728; C08F 20/10; G03G 9/08711; G03G 9/08731; G03G 9/08755; G03G 9/08782

(57) ABSTRACT

A toner comprising a toner particle comprising a binder resin and an ester wax W1, wherein the binder resin comprises a crystalline vinyl resin having a specific monomer unit (a), and an amorphous vinyl resin, the ester wax W1 is a specific ester compound when a cross section of the toner is observed by a scanning transmission electron microscope, a phase separation structure having a crystalline phase comprising the crystalline vinyl resin as a main component and an amorphous phase comprising the amorphous vinyl resin as a main component is present in the cross section of the toner particle, and domains containing the ester wax W1 as a main component are present in the amorphous phase.

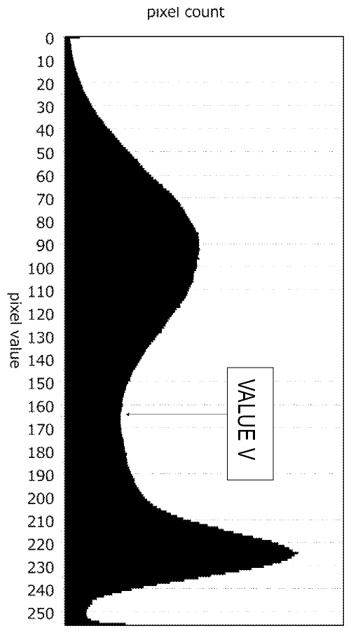

### BACKGROUND

### Field of the Technology

The present disclosure relates to a toner that is used in an electrophotographic method and an electrostatic recording method.

### Description of the Related Art

In the related art, energy saving has been considered as a major technical issue in electrophotographic devices as well, and ways of significantly reducing the amount of heat applied to fixing devices have been investigated. There is an increasing need for toners that can be fixed with lower energy, that is, toners with so-called “low-temperature fixability”.

As a method for enabling fixation at a low temperature, a toner with a plasticizer added thereto is examined in WO 2013/047296, for example. The plasticizer has an effect of increasing a softening rate of a binder resin while maintaining a glass transition temperature (Tg) of a toner, and can improve low-temperature fixability. However, since the toner is softened after a step of plasticizing the binder resin after the plasticizer is melted, the melting speed of the toner is limited, and it is desirable to further improve the low-temperature fixability.

In recent years, a method using a crystalline resin as a binder resin in order to further improve low-temperature fixability has been investigated. Amorphous resins that are generally used as toner binder resins do not exhibit clear endothermic peaks in differential scanning calorimeter (DSC) measurement, while crystalline resins exhibit endothermic peaks (melting points) in DSC measurement.

The crystalline resins have regularly arranged molecular chains and thus have a property of minimal softening at temperatures lower than the melting points. In addition, when the melting points are exceeded, crystals rapidly melt, and accordingly, a rapid viscosity decrease is caused. Therefore, the crystalline resins have attracted attention as materials having an excellent sharp melt property and capable of achieving low-temperature fixability.

On the other hand, the crystalline resins have a problem that their viscosities are likely to decrease at high temperatures and their hot offset resistance and heat-resistant storability during storage at high temperatures are likely to decrease. As a countermeasure against this problem, Japanese Patent Laid-Open No. 2014-142632 and Japanese Patent Laid-Open No. 2024-001777 disclose toners in which domains composed of amorphous resins are present in matrices composed of crystalline resins.

### SUMMARY

The present inventors have realized that in a case where a toner having a matrix made of a crystalline vinyl resin and domains made of an amorphous vinyl resin is used for double-sided printing in a high-speed process, discharged paper sticking in which paper sheets placed on a discharged paper tray are bonded to each other is likely to occur.

As a result of further investigation, the present inventors have found that in a case where the above-described toner having a matrix domain structure is fixed, recrystallization of the crystalline vinyl resin is delayed at an interface between the matrix and the domains inside the toner. This is presumed to be because the amorphous vinyl resin and the crystalline vinyl resin are mixed when the toner is melted in the fixing step and arrangement of the crystalline vinyl resin upon cooling is thus hindered by the amorphous vinyl resin.

It is considered that due to such delay of recrystallization of the crystalline vinyl resin, the papers are likely to be discharged with the toner remaining in a softened state, and in a case where double-sided printing is performed using a high-speed process image forming device, in particular, the toner in the softened state is bonded between images on papers placed on the discharged paper tray.

The present disclosure provides a toner which suppresses discharged paper sticking in a high-speed printing process and has excellent low-temperature fixability, hot offset resistance, and heat-resistant storability.

The present disclosure relates to a toner comprising a toner particle comprising a binder resin and an ester wax W1, wherein the binder resin comprises a crystalline vinyl resin having a monomer unit (a) represented by Formula (1) below, and an amorphous vinyl resin,

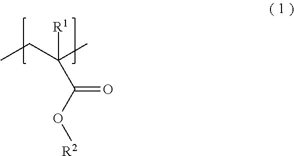

in Formula (1), R¹ represents a hydrogen atom or a methyl group, and R² represents a linear saturated alkyl group having 16 to 36 carbon atoms, the ester wax W1 is at least one ester compound selected from the group consisting of Formulas (2-1) to (2-3) below,

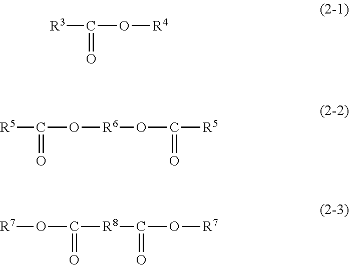

in Formula (2-1), R³ represents a linear saturated alkyl group having 13 to 29 carbon atoms, and R⁴ represents a linear saturated alkyl group having 14 to 30 carbon atoms, in Formula (2-2), R⁵ each independently represents a linear saturated alkyl group having 13 to 29 carbon atoms, and R⁶ represents a linear saturated alkylene group having 16 or less carbon atoms, in Formula (2-3), R⁷ each independently represents a linear saturated alkyl group having 14 to 30 carbon atoms, and R⁸ represents a linear saturated alkylene group having 14 or less carbon atoms, when a cross section of the toner is observed by a scanning transmission electron microscope, a phase separation structure having a crystalline phase comprising the crystalline vinyl resin as a main component and an amorphous phase comprising the amorphous vinyl resin as a main component is present in the cross section of the toner particle, and domains containing the ester wax W1 as a main component are present in the amorphous phase.

Features of the present disclosure will become apparent from the following description of embodiments with reference to the attached drawing. The following description of embodiments is described by way of example.

### BRIEF DESCRIPTION OF THE DRAWING

The FIGURE is a diagram of a brightness histogram of 256 gradations obtained from a cross-sectional image of a toner particle.

### DESCRIPTION OF THE EMBODIMENTS

In the present disclosure the notations “from XX to YY” and “XX to YY” representing a numerical value range signify, unless otherwise specified, a numerical value range that includes the lower limit and the upper limit of the range, as endpoints. In a case where numerical value ranges are described in stages, the upper limits and the lower limits of the respective numerical value ranges can be combined arbitrarily. In the present disclosure, for instance, a wording such as “at least one selected from the group consisting of XX, YY and ZZ” encompasses XX, YY and ZZ, a combination of XX and YY, a combination of XX and ZZ, a combination of YY and ZZ, and a combination of XX, YY and ZZ. In the case where XX represents a group, a plurality of members may be selected from XX, and the same is true for YY and ZZ.

The term (meth)acrylic acid ester refers to an acrylic acid ester and/or methacrylic acid ester.

The term “monomer unit” refers to a reacted form of a monomer substance in a polymer. For example, one unit is one carbon-carbon bond segment in a main chain of a polymerizable monomer in a polymer. The polymerizable monomer can be represented by Formula (C) below.

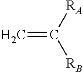

In Formula (C), R_{A} represents a hydrogen atom or an alkyl group (preferably an alkyl group having 1 to 3 carbon atoms, more preferably a methyl group), and R_{B} represents an optional substituent.

The “crystalline resin” refers to a resin that exhibits a clear endothermic peak in differential scanning calorimeter (DSC) measurement.

The present inventors have found that a toner with the following configuration can solve the above-mentioned problem.

That is, the present disclosure relates to a toner comprising a toner particle comprising a binder resin and an ester wax W1, wherein the binder resin comprises a crystalline vinyl resin having a monomer unit (a) represented by Formula (1) below, and an amorphous vinyl resin,

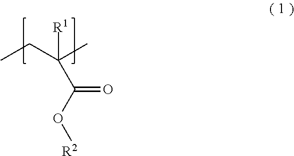

in Formula (1), R¹ represents a hydrogen atom or a methyl group, and R² represents a linear saturated alkyl group having 16 to 36 carbon atoms, the ester wax W1 is at least one ester compound selected from the group consisting of Formulas (2-1) to (2-3) below,

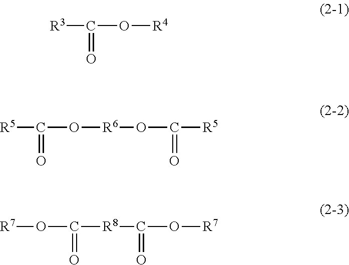

in Formula (2-1), R³ represents a linear saturated alkyl group having 13 to 29 carbon atoms, and R⁴ represents a linear saturated alkyl group having 14 to 30 carbon atoms, in Formula (2-2), R⁵ each independently represents a linear saturated alkyl group having 13 to 29 carbon atoms, and R⁶ represents a linear saturated alkylene group having 16 or less carbon atoms, in Formula (2-3), R⁷ each independently represents a linear saturated alkyl group having 14 to 30 carbon atoms, and R⁸ represents a linear saturated alkylene group having 14 or less carbon atoms, when a cross section of the toner is observed by a scanning transmission electron microscope, a phase separation structure having a crystalline phase comprising the crystalline vinyl resin as a main component and an amorphous phase comprising the amorphous vinyl resin as a main component is present in the cross section of the toner particle, and domains containing the ester wax W1 as a main component are present in the amorphous phase.

The present inventors have considered a mechanism capable of solving the above-mentioned problem by the above-mentioned toner as follows.

As described above, a toner having a phase separation structure including a crystalline vinyl resin phase and an amorphous vinyl resin phase has been proposed in the related art. In a case of such a toner, it is presumed that a recrystallization rate when the crystalline vinyl resin that is present in the vicinity of the interface between the two phases after the toner is melted in the fixing step decreases due to the amorphous vinyl resin that is present in the periphery. As a result, the papers are likely to be discharged with the toner maintained in the softened state, and in a case where double-sided printing is performed using a high-speed process image forming device, in particular, the toner in the softened state is bonded between images on the papers placed on the discharged paper tray.

On the other hand, the present inventors have focused on a configuration containing an ester wax W1 as a means for improving the recrystallization rate of the crystalline vinyl resin that is present in the vicinity of the above-mentioned interface between the two phases.

The ester wax is generally a crystalline material and is quickly recrystallized after being melted in the fixing step because the molecular weight thereof is smaller than that of the crystalline resin. The present inventors have found on the basis of this nature that the recrystallization rate of the crystalline vinyl resin can be improved by making the crystalline vinyl resin interact with the ester wax even in a case where the amorphous vinyl resin is present in the periphery of the crystalline vinyl resin.

Furthermore, the present inventors have found that in order to bring about the interaction between the crystalline vinyl resin and the ester wax more effectively in the vicinity of the above-mentioned interface between the two phases, it is necessary for domains containing the ester wax W1 as a main component to be present in the amorphous phase. If the domains containing the ester wax W1 as a main component are present in the amorphous phase, the ester wax W1 tends to be present in the vicinity of the interface between the crystalline phase and the amorphous phase when the crystalline vinyl resin is melted and recrystallized at the time of fixation. This causes the interaction between the crystalline vinyl resin and the ester wax W1 in the vicinity of the interface between the two phases to more effectively occur, the recrystallization rate of the crystalline vinyl resin is raised, and discharged paper sticking is thus suppressed.

In a case where the domains of the ester wax W1 are not present, the effect of improving the recrystallization rate of the crystalline vinyl resin cannot be obtained, and discharged paper sticking thus occurs. Also, in a case where the domains of the ester wax W1 are present only in the crystalline phase, the amount of the ester wax supplied to the interface between the crystalline phase and the amorphous phase decreases. Therefore, the effect of improving the recrystallization rate of the crystalline vinyl resin at the interface cannot be obtained, and the discharged paper sticking thus occurs.

As described above, the present inventors have found that the above-mentioned problem can be solved by causing the structure of the ester to be likely to interact with the crystalline vinyl resin and forming the domains of the ester wax in the amorphous phase.

Hereinafter, a toner of the present disclosure will be described in detail.

### Cross-Sectional Structure of Toner Particle

The toner includes a toner particle containing a binder resin and an ester wax W1. The binder resin contains a crystalline vinyl resin having a monomer unit (a) represented by Formula (1) and an amorphous vinyl resin.

When a cross section of a toner is observed by a scanning transmission electron microscope, a phase separation structure having a crystalline phase including the crystalline vinyl resin as a main component and an amorphous phase including the amorphous vinyl resin as a main component is present in the cross section of the toner particle.

In the observation of the cross section of the toner particle, the presence of the phase separation structure having the crystalline phase and the amorphous phase provides excellent low-temperature fixability, hot offset resistance, and heat-resistant storability.

Also, an area ratio S1 of the amorphous phase with respect to the area of the crystalline phase in the cross section of the toner particle is, for example, 15.0% to 115.0%. The area ratio S1 is a value of the area of the amorphous phase when the area of the crystalline phase is defined as 100.0. From the viewpoint of more highly achieving both the discharged paper sticking suppression effect and the hot offset resistance, S1 is preferably 20.0% to 100.0%, is more preferably 40.0% to 95.0%, and is even more preferably 50.0% to 70.0%.

In the observation of the cross section of the toner particle, domains containing the ester wax W1 as a main component are present in the amorphous phase. If the domains containing the ester wax W1 as a main component are present in the amorphous phase, the ester wax W1 tends to be present near the interface between the crystalline phase and the amorphous phase when the crystalline vinyl resin is melted and recrystallized at the time of fixing. This causes the interaction between the crystalline vinyl resin and the ester wax W1 in the vicinity of the interface between the two phases to more effectively occur, the recrystallization rate of the crystalline vinyl resin is raised, and discharged paper sticking is thus suppressed.

When no domains are present, an effect of improving the recrystallization speed of the crystalline vinyl resin is not obtained, and discharged paper sticking occurs. Also, in a case where the domains of the ester wax W1 are present only in the crystalline phase, the amount of ester wax W1 supplied to the location near the interface between the crystalline phase and the amorphous phase decreases, the effect of improving the recrystallization speed of the crystalline vinyl resin at the interface cannot be obtained, and discharged paper sticking occurs.

A method of forming the domains containing the ester wax W1 as a main component in the amorphous phase including the amorphous vinyl resin as a main component in the toner is not particularly limited. For example, it is possible to form the domains by adding a cooling process after a toner particle polymerization process ends in a toner manufacturing method using a suspension polymerization method, which will be described later, and controlling a cooling speed and the like. This is considered to be because the ester wax W1 that is mixed together in the amorphous phase after polymerization is fixed inside the amorphous phase through cooling and the recrystallization advances as it is. Furthermore, it is also possible to form the domains by appropriately controlling the type of the ester wax.

More specifically, the cooling speed, for example, may be raised to form the domains in the amorphous phase. Also, at least one ester compound selected from the group consisting of Formulas (2-1) to (2-3) may be used as the ester wax.

Furthermore, the number average value of the long diameters of the domains of the ester wax W1 that are present in the amorphous phase in the cross section of the toner particle is defined as d (nm). At this time, a value d/D of a ratio of d with respect to the number average particle diameter D (nm) of the toner is, for example, 2.3×10⁻³ to 4.0×10⁻² and preferably satisfies Expression (3) below:

$$2.5 \times 1 {0}^{- 3} \leq d / D \leq 3.3 \times 1 {0}^{- 2} . \qquad ( 3 )$$

The interaction between the crystalline vinyl resin and the ester wax W1 is more effectively caused, the recrystallization speed of the crystalline vinyl resin is raised, and the discharged paper sticking inhibition effect is further improved, by the ratio d/D satisfying Expression (3).

The value d/D of the ratio more preferably satisfies Expression (6) below:

$$3. 5 \times 1 {0}^{- 3} \leq d / D \leq 1.5 \times 1 {0}^{- 2} . \qquad ( 6 )$$

A method of controlling the number average value d is not particularly limited. The number average value d can be more appropriately controlled by performing the cooling process and an annealing process in the toner manufacturing method using a suspension polymerization method, which will be described later, under preferable conditions. Furthermore, it is also possible to form the domains by appropriately controlling the type of the ester wax.

More specifically, the cooling speed may be set to be equal to or greater than 10° C./min, for example, to satisfy Expression (3), and d is likely to decrease as the cooling speed increases. Also, d tends to increase as the annealing time increases in the annealing process. Moreover, at least one ester compound selected from the group consisting of Formulas (2-1) to (2-3) may be used as the ester wax.

A method of controlling the number average particle diameter D (nm) of the toner is also not particularly limited. For example, there is a method of causing an inorganic or organic dispersion stabilizer to be contained in an aqueous medium when a polymerizable monomer composition is dispersed using a stirrer or the like in the aqueous medium in the toner manufacturing method using a suspension polymerization method, which will be described later. It is possible to appropriately control the number average particle diameter D (nm) by adjusting the type or the amount of dispersion stabilizer used.

In the observation of the cross section of the toner particle, the number nd of domains containing the ester wax W1 as a main component, which are present in the amorphous phase, per toner particle is, for example, 40.0 to 420.0, is preferably 50.0 to 350.0, and is more preferably 150.0 to 300.0. The paper discharge sticking control effect is more easily improved by nd falling within the above-mentioned range.

nd can be controlled by the amount of the ester wax W1 or by the cooling process in the manufacturing of the toner particle. nd tends to increase as the cooling speed is raised.

### Configuration of Toner Particle

The toner particle contains the binder resin and the ester wax W1. The toner particle may include an ester wax other than the ester wax W1, a releasing agent, a colorant, a charge control agent, and the like to such an extent that the effects of the present disclosure are not impaired, in addition to the binder resin and the ester wax W1.

### Binder Resin

The binder resin contains a crystalline vinyl resin and an amorphous vinyl resin.

### Crystalline Vinyl Resin

The binder resin contains a crystalline vinyl resin having a monomer unit (a) represented by Formula (1) below.

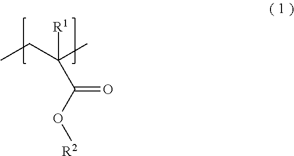

In Formula (1), R¹ represents a hydrogen atom or a methyl group, and R² represents a linear saturated alkyl group having 16 to 36 carbon atoms.

The monomer unit (a) has a long chain alkyl group. The vinyl resin becomes a crystalline vinyl resin by having the monomer unit (a). In a case where R² in Formula (1) is a linear saturated alkyl group having 16 to 36 carbon atoms, crystallinity of the crystalline vinyl resin is likely to be expressed. R² is preferably a linear saturated alkyl group having 18 to 30 carbon atoms. R² more preferably has 18 to 26 carbon atoms, further preferably has 20 to 24 carbon atoms, and yet more preferably has 22 carbon atoms.

The crystalline resin will be described. The crystalline resin contains a crystalline vinyl resin, and it may additionally contain a polyester resin, a polyurethane resin, an epoxy resin, or the like that has crystallinity.

The crystalline vinyl resin will be described.

Examples of a method of introducing the monomer unit (a) into the crystalline vinyl resin include a method of polymerizing (meth)acrylic acid ester as follows. Examples thereof include stearyl (meth)acrylate, nonadecyl (meth)acrylate, eicosyl (meth)acrylate, heneicosanyl (meth)acrylate, behenyl (meth)acrylate, lignoceryl (meth)acrylate, ceryl (meth)acrylate, octacosa (meth)acrylate, myricyl (meth)acrylate, dotriacontyl (meth)acrylate, and 2-decyltetradecyl (meth)acrylate.

As the monomer unit (a) in Formula (1), one kind may be used alone, or two or more kinds may be used together. The crystalline vinyl resin may include another unit in addition to the monomer unit (a). Examples of a method of introducing another unit into the crystalline vinyl resin include a method of polymerizing (meth)acrylic acid ester that may form the above-described monomer unit (a) with another vinyl-based monomer.

Examples of the other vinyl-based monomer include the following:

(Meth)acrylic acid esters such as styrene, α-methylstyrene, methyl (meth)acrylate, ethyl (meth)acrylate, n-butyl (meth)acrylate, t-butyl (meth)acrylate, 2-ethylhexyl (meth)acrylate, and lauryl (meth)acrylate.

Monomers having a nitrile group: for example, acrylonitrile and methacrylonitrile.

Monomers having a urea group: for example, a monomer obtained by reacting an amine having 3 to 22 carbon atoms [a primary amine (such as normal-butylamine, t-butylamine, propylamine, and isopropylamine), a secondary amine (such as di-normal-ethylamine, di-normal-propylamine, and di-normal-butylamine), aniline, cycloxylamine, and the like] with an isocyanate having 2 to 30 carbon atoms having an ethylenically unsaturated bond by a known method.

Monomers having a carboxy group; for example, methacrylic acid, acrylic acid, and 2-carboxyethyl (meth)acrylate.

Monomers having a hydroxy group; for example, 2-hydroxyethyl (meth)acrylate, 2-hydroxypropyl (meth)acrylate, etc.

Monomers having an amide group; for example, acrylamide, and monomers obtained by reacting an amine having 1 to 30 carbon atoms with a carboxylic acid having 2 to 30 carbon atoms and having an ethylenically unsaturated bond (acrylic acid, methacrylic acid, etc.) by a known method.

Monomers having a lactam structure; for example, N-vinyl-2-pyrrolidone.

Among these, it is preferable to use at least one selected from the group consisting of acrylonitrile and methacrylonitrile, which are monomers having nitrile groups, and N-vinyl-2-pyrrolidone, which is a monomer having a lactam structure. In other words, the crystalline vinyl resin having a monomer unit of at least one monomer selected from the group consisting of acrylonitrile, methacrylonitrile, and N-vinyl-2-pyrrolidone is preferably used. The crystalline vinyl resin more preferably has a monomer unit of at least one monomer selected from the group consisting of acrylonitrile and methacrylonitrile (further preferably acrylonitrile).

The nitrile group and lactam structure have low affinity with the ester wax W1 and can more easily and effectively coordinate the ester wax W1 with respect to the monomer unit (a), which is a site where the crystallinity is expressed in the crystalline vinyl resin. Therefore, the recrystallization speed of the crystalline vinyl resin can be easily improved, and the effect of suppressing discharge paper sticking can be further enhanced.

The content rate of the monomer unit (a) in the crystalline vinyl resin is preferably 20.0% by mass to 90.0% by mass, is more preferably 25.0% by mass to 85.0% by mass, and is further preferably 40.0% by mass to 80.0% by mass. Within this range, a more excellent balance between low-temperature fixability and heat-resistant storability is achieved.

The crystalline vinyl resin preferably contains 1.0% by mass to 25.0% by mass and more preferably contains 3.0% by mass to 20.0% by mass of monomer unit of at least one selected from the group consisting of acrylonitrile, methacrylonitrile, and N-vinyl-2-pyrrolidone (further preferably acrylonitrile).

The crystalline vinyl resin preferably contains 2.0% by mass to 40.0% by mass and more preferably 5.0% by mass to 30.0% by mass of monomer unit of styrene.

The crystalline vinyl resin preferably contains 1.0% by mass to 20.0% by mass and more preferably contains 2.0% by mass to 10.0% by mass of monomer unit of (meth)acrylic acid-n-butyl.

The crystalline vinyl resin can be obtained by, for example, copolymerizing (meth)acrylic acid ester for introducing the above-described monomer unit (a) with another vinyl-based monomer. It is also possible to use the obtained crystalline vinyl resin as a precursor and to cause another vinyl-based monomer to further react by a hydrogen abstraction reaction.

The hydrogen abstraction reaction is a reaction of generating radicals by removing hydrogen atoms bonded to carbon atoms, and it is possible to cause another vinyl-based monomer to further react from generated radicals. It is thus possible to form a state where the monomer unit (a) in the crystalline vinyl resin is more aggregated in a molecule, and the crystallinity is more likely to be enhanced.

In the crystalline vinyl resin, the weight average molecular weight (Mw) of a tetrahydrofuran (THF)-soluble content measured by gel permeation chromatography (GPC) is preferably from 30000 to 300000. When the Mw is within this range, it is easier to adjust the melting point of the crystalline vinyl resin for exhibiting low-temperature fixability to be within an appropriate range. Mw is more preferably from 40000 to 250000 and is further preferably from 60000 to 200000.

The content rate M1 of the crystalline vinyl resin in the binder resin is, for example, 5.0% by mass to 85.0% by mass, is preferably 5.0% by mass to 70.0% by mass, is more preferably 10.0% by mass to 70.0% by mass, is further preferably 14.0% by mass to 67.0% by mass, and yet further preferably 45.0% by mass to 60.0% by mass. Within this range, more excellent low temperature fixability and hot offset resistance are achieved.

### Amorphous Vinyl Resin

Here, the binder resin contains an amorphous vinyl resin.

As a vinyl-based monomer constituting the amorphous vinyl resin, it is possible to use above-described vinyl-based monomers that can be used for the crystalline vinyl resin. It is also possible to use (meth)acrylic acid ester to introduce the monomer unit (a) within a range in which the amorphous vinyl resin does not exhibit crystallinity.

Among these, the amorphous vinyl resin preferably has a monomer unit (b) represented by Formula (4) below.

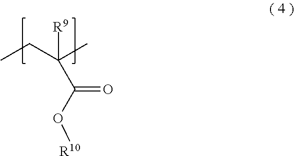

In Formula (4), R⁹ represents a hydrogen atom or a methyl group, and R¹⁰ represents a linear saturated alkyl group having, for example, 2 to 18 carbon atoms, preferably 4 to 12 carbon atoms.

In a case where the amorphous vinyl resin contains the above-described structure, it becomes easy to form the domains of the ester wax W1 in the amorphous phase and to further exhibit the discharge paper sticking suppression effect.

It is also possible to use a so-called crosslinking agent that contains a plurality of vinyl groups per monomer. Examples of the crosslinking agent include the following: diethylene glycol diacrylate, triethylene glycol diacrylate, tetraethylene glycol diacrylate, polyethylene glycol diacrylate, 1,6-hexanediol diacrylate, neopentyl glycol diacrylate, tripropylene glycol diacrylate, polypropylene glycol diacrylate, 2,2′-bis(4-(acryloxydiethoxy)phenyl)propane, trimethylolpropane triacrylate, tetramethylolmethane tetraacrylate, ethylene glycol dimethacrylate, diethylene glycol dimethacrylate, triethylene glycol dimethacrylate, tetraethylene glycol dimethacrylate, polyethylene glycol dimethacrylate, 1,3-butylene glycol dimethacrylate, 1,6-hexanediol dimethacrylate, neopentyl glycol dimethacrylate, polypropylene glycol dimethacrylate, 2,2′-bis(4-(methacryloxydiethoxy)phenyl)propane, 2,2′-bis(4-(methacryloxypolyethoxy)phenyl)propane, trimethylolpropane trimethacrylate, tetramethylolmethane tetramethacrylate, divinylbenzene, divinylnaphthalene, divinyl ether, 4,4′-divinylbiphenyl, and the like.

The content rate of the amorphous vinyl resin in the binder resin is, for example, 10.0% by mass to 80.0% by mass, is preferably 10.0% by mass to 75.0% by mass, is more preferably 20.0% by mass to 75.0% by mass, and is further preferably 30.0% by mass to 75.0% by mass.

### Amorphous Polyester Resin

The binder resin preferably contains an amorphous polyester resin as an amorphous resin in addition to the amorphous vinyl resin.

As the amorphous polyester resin, an amorphous polyester resin that can be obtained by a reaction of dihydric or higher carboxylic acid and dihydric or higher alcohol can be used. In other words, the amorphous polyester resin is preferably a condensation polymer of dihydric or higher carboxylic acid and dihydric or higher alcohol.

Examples of a polyvalent carboxylic acid include the following compounds:
dibasic acids such as succinic acid, adipic acid, sebacic acid, phthalic acid, isophthalic acid, terephthalic acid, malonic acid, and dodecenyl succinic acid, anhydrides thereof or lower alkyl esters thereof, and aliphatic unsaturated dicarboxylic acids such as maleic acid, fumaric acid, itaconic acid, and citraconic acid; trimellitic acid and anhydrides thereof, trimesic acid, pyromellitic acid, naphthalene tricarboxylic acid, and lower alkyl esters thereof. One kind of these may be used alone, or two or more kinds of these may be used together.

As the polyvalent carboxylic acid, trimellitic acid and their anhydrides, isophthalic acid, dodecenylsuccinic acid are preferably used.

Examples of polyvalent alcohol include the following compounds:
alkylene glycol (ethylene glycol, 1,2-propylene glycol and 1,3-propylene glycol); alkylene ether glycol (polyethylene glycol and polypropylene glycol); alicyclic diol (1,4-cyclohexanedimethanol); bisphenol (bisphenol A); alkylene oxides of alicyclic diols (ethylene oxide and propylene oxide) adducts. The alkyl moieties of alkylene glycol and alkylene ether glycol may be linear or branched. Further examples thereof include glycerin, trimethylolethane, trimethylolpropane, and pentaerythritol. One kind of these may be used alone, or two or more kinds of these may be used together.

The polyvalent alcohol is preferably a 1 to 5 mole adduct of alkylene oxide (ethylene oxide and/or propylene oxide) of bisphenol A.

Here, in order to adjust the acid value and the hydroxyl value, as necessary, monovalent acids such as acetic acid and benzoic acid, and monovalent alcohols such as cyclohexanol and benzyl alcohol can also be used.

The amorphous polyester resin preferably has a monomer unit (c) (for example, an alkenyl succinic acid unit) represented by Formula (5) below.

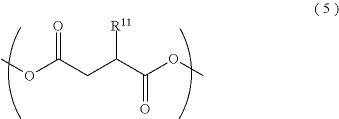

In Formula (5), R¹¹ represents an alkyl group or an alkenyl group having 8 to 16 carbon atoms.

It is possible to exhibit an effect of further promoting an interaction between the crystalline vinyl resin having R² and the ester wax W1 by the amorphous polyester resin including the monomer unit (c) represented by Formula (5) and to further improve the recrystallization speed of the crystalline vinyl resin. As a result, discharged paper sticking is more easily suppressed.

Therefore, it is preferable to produce an amorphous polyester resin using dodecenyl succinic acid among the above-mentioned dibasic acids which can be used for the amorphous polyester resin.

The content rate of the monomer unit represented by Formula (5) in the amorphous polyester resin is preferably 3% by mass to 30% by mass and is more preferably 5% by mass to 20% by mass. In terms of mol %, the content rate is preferably 0.3 mol % to 30 mol % and is more preferably 8 mol % to 25 mol %.

Although a method of manufacturing the amorphous polyester resin is not particularly limited, it is possible to use a transesterification method or a direct polycondensation method alone or by in combination, for example.

The content rate M3 of the amorphous polyester resin in the binder resin is, for example, 0.7% by mass to 18.0% by mass, is preferably 1.0% by mass to 15.0% by mass, is more preferably 2.0% by mass to 15.0% by mass, and is further preferably 2.0% by mass to 10.0% by mass. Within this range, more excellent low temperature fixability and discharged paper sticking suppression effect can be achieved.

### Wax

The toner particle contains the ester wax W1.

The ester wax W1 is at least one ester compound selected from the group consisting of Formulas (2-1) to (2-3).

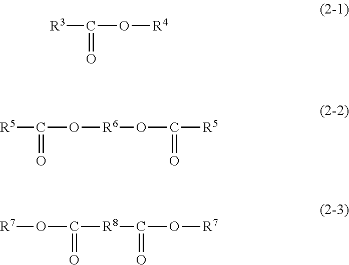

In Formula (2-1), R³ represents a linear saturated alkyl group having 13 to 29 carbon atoms, and R⁴ represents a linear saturated alkyl group having 14 to 30 carbon atoms.

In a case where R³ is a linear saturated alkyl group having 12 or less carbon atoms and/or R⁴ is a linear saturated alkyl group having 13 or less carbon atoms, heat-resistant storability is degraded.

In a case where R³ is a linear saturated alkyl group having 30 or more carbon atoms and/or R⁴ is a linear saturated alkyl group having 31 or more carbon atoms, an interaction with the crystalline vinyl resin is degraded, the effect of improving the recrystallization speed is degraded, and discharged paper sticking occurs.

It is preferable that R³ be a linear saturated alkyl group having 17 to 21 carbon atoms from the viewpoint of suppressing discharged paper sticking. Also, it is preferable that R⁴ be a linear saturated alkyl group having 18 to 22 carbon atoms from the viewpoint of suppressing discharged paper sticking.

The ester wax W1 is more preferably at least one ester compound selected from the group consisting of Formulas (2-2) and (2-3) from the viewpoint of suppressing discharged paper sticking.

In Formula (2-2), R⁵ each independently represents a linear saturated alkyl group having 13 to 29 carbon atoms, and R⁶ represents a linear saturated alkylene group having 16 or less carbon atoms.

In a case where R⁵ is a linear saturated alkyl group having 12 or less carbon atoms, heat-resistant storability is degraded. In a case where R⁵ is a linear saturated alkyl group having 30 or more carbon atoms, an interaction with the crystalline vinyl resin is degraded, the effect of improving the recrystallization speed is degraded, and discharged paper sticking thus occurs.

Also, in a case where R⁶ is a linear saturated alkylene group having 17 or more carbon atoms, crystallinity of the ester wax W1 is degraded, the effect of improving the recrystallization speed of the crystalline vinyl resin is degraded, and discharged paper sticking thus occurs.

In Formula (2-2), it is preferable that R⁵ be independently a linear saturated alkyl group having 17 to 25 carbon atoms from the viewpoint of suppressing discharged paper sticking. It is preferable that R⁶ be a linear saturated alkylene group having 2 to 10 carbon atoms from the viewpoint of suppressing discharged paper sticking.

In Formula (2-3), R⁷ each independently represents a linear saturated alkyl group having 14 to 30 carbon atoms, and R⁸ represents a linear saturated alkylene group having 14 or less carbon atoms.

In a case where R⁷ is a linear saturated alkyl group having 13 or less carbon atoms, heat-resistant storability is degraded. In a case where R⁷ is a linear saturated alkyl group having 31 or more carbon atoms, an interaction with the crystalline vinyl resin is degraded, the effect of improving the recrystallization speed is degraded, and discharged paper sticking thus occurs.

Also, in a case where R⁸ is a linear saturated alkylene group having 15 or more carbon atoms, crystallinity of the ester wax W1 is degraded, the effect of improving the recrystallization speed of the crystalline vinyl resin is degraded, and discharged paper sticking thus occurs.

In Formula (2-3), it is preferable that R⁷ be independently a linear saturated alkyl group having 17 to 25 carbon atoms from the viewpoint of suppressing discharged paper sticking. It is preferable that R⁸ be a linear saturated alkylene group having 2 to 8 carbon atoms from the viewpoint of suppressing discharged paper sticking.

The content M2 of the ester wax W1 with respect to 100 parts by mass of crystalline vinyl resin is, for example, 9.0 parts by mass to 57.0 parts by mass. The content M2 is preferably 10.0 parts by mass to 50.0 parts by mass from the viewpoint of achieving both the discharged paper sticking suppression effect and the heat-resistant storability. The content M2 is more preferably 13.0 parts by mass to 35.0 parts by mass and is further preferably 15.0 parts by mass to 30.0 parts by mass.

Furthermore, it is preferable that an absolute value of a difference between the number of carbon atoms in R² in Formula (1) and the number of carbon atoms included in the saturated alkyl group of ester wax W1 satisfy any of the following conditions (i) to (iii). As the difference between the numbers of carbon atoms in the crystalline vinyl resin and the side chain alkyl group of the ester wax W1 is smaller, it is possible to further improve the recrystallization speed of the crystalline vinyl resin and to suppress discharged paper sticking in a further advanced manner.

(i) The ester wax W1 includes the ester compound represented by Formula (2-1) described above, and either an absolute value (|C_{R3}−C_{R2}|) of a difference between the number of carbon atoms included in R² and the number of carbon atoms included in R³ or an absolute value (|C_{R4}−C_{R2}|) of a difference between the number of carbon atoms included in R² and the number of carbon atoms included in R⁴ is equal to or less than eight, for example, and is more preferably equal to or less than four. The lower limit is not particularly limited and is preferably equal to or greater than zero.

(ii) The ester wax W1 includes the ester compound represented by Formula (2-2), and an absolute value (|C_{R5}−C_{R2}|) of a difference between the number of carbon atoms included in R² and the number of carbon atoms included in R⁵ is, for example, equal to or less than nine and is more preferably equal to or less than four. The lower limit is not particularly limited and is preferably equal to or greater than zero or equal to or greater than one.

(iii) The ester wax W1 includes the ester compound represented by Formula (2-3), and an absolute value (|C_{R7}−C_{R2}|) of a difference between the number of carbon atoms included in R² and the number of carbon atoms included in R⁷ is, for example, equal to or less than nine and is preferably equal to or less than four. The lower limit is not particularly limited and is preferably equal to or greater than zero.

The toner particle preferably further contains an ester wax W2 in addition to the ester wax W1. The ester wax W2 is preferably at least one ester compound selected from the group consisting of an ester compound of a tetrahydric to octahydric (preferably tetrahydric to hexahydric) alcohol and an aliphatic monocarboxylic acid and an ester compound of a tetracarboxylic to octacarboxylic (preferably tetracarboxylic to hexacarboxylic) acid and an aliphatic monoalcohol.

It is possible to exhibit an effect of further promoting an interaction between the crystalline vinyl resin having R² and the ester wax W1 and to further improve the recrystallization speed of the crystalline vinyl resin by the toner particle containing the ester wax W2. As a result, discharged paper sticking is more easily suppressed.

The content of the ester wax W2 is, for example, 1.0 parts by mass to 15.0 parts by mass, is more preferably 2.0 parts by mass to 10.0 parts by mass, and is more preferably 3.0 parts by mass to 8.0 parts by mass with respect to 100 parts by mass of binder resin.

The content of the ester wax W1 is, for example, 1.0 parts by mass to 25.0 parts by mass, is more preferably 2.0 parts by mass to 20.0 parts by mass, and is more preferably 4.0 parts by mass to 19.0 parts by mass with respect to 100 parts by mass of binder resin.

The ester wax W1 preferably contains an ester wax represented by Formula (2-2). The ester wax W2 is preferably an ester compound of a tetrahydric to octahydric (preferably tetrahydric to hexahydric) alcohol and an aliphatic monocarboxylic acid A2.

When a linear saturated alkyl group included in the aliphatic monocarboxylic acid A2 is defined as R¹², an absolute value (|C_{R5}−C_{R2}|) of a difference between the number of carbon atoms in R² and the number of carbon atoms in R⁵ is preferably equal to or less than four. An absolute value (|C_{R12}−C_{R2}|) of a difference between the number of carbon atoms in R² and the number of carbon atoms in R¹² is, for example, equal to or less than eight and is preferably equal to or less than four. An absolute value (|C_{R12}−C_{R5}|) of a difference between the number of carbon atoms in R¹² and the number of carbon atoms in R⁵ is, for example, equal to or less than seven and is preferably equal to or less than four.

In a case where the number of carbon atoms in the alkyl group in the aliphatic monocarboxylic acid A2 constituting the ester wax W2 satisfies the above relationship, an effect of further promoting an interaction between the crystalline vinyl resin and the ester wax W1 is exhibited, and the recrystallization speed of the crystalline vinyl resin is further improved. As a result, discharged paper sticking is further easily suppressed.

The number of carbon atoms in R¹² is, for example, 15 to 35, is preferably 17 to 29, is more preferably 17 to 25, is further preferably 19 to 23, and is yet more preferably 21.

In a case where the toner particle further contains the ester wax W2, the ester wax W2 is preferably any of esters of tetrahydric alcohols and monocarboxylic acids, such as pentaerythritol tetrastearate, pentaerythritol tetrapalmitate, and pentaerythritol tetrabehenate, esters of hexahydric alcohols and monocarboxylic acids, such as dipentaerythritol hexastearate, dipentaerythritol hexapalmitate, and dipentaerythritol hexabehenate, and esters of octahydric alcohols and monocarboxylic acids, such as tripentaerythritol octastearate, tripentaerythritol octapalmitate, and tripentaerythritol octabehenate.

Also, the toner particle may contain a hydrocarbon-based wax. It becomes easy to secure releasability, and better hot offset resistance is achieved.

Although the hydrocarbon-based wax is not particularly limited, examples thereof include the following:

aliphatic hydrocarbon-based waxes; low-molecular-weight polyethylene, low-molecular-weight polypropylene, low-molecular-weight olefin copolymers, Fischer-Tropsch wax, and waxes obtained by oxidizing or adding acids to these waxes.

### Colorant

The toner may contain a colorant. Examples of colorants include known organic pigments, organic dyes, inorganic pigments, carbon black as a black colorant, and magnetic particles. Other colorants that are conventionally used in toners may also be used.

Examples of a yellow colorant include the following: condensed azo compounds, isoindolinone compounds, anthraquinone compounds, azo metal complexes, methine compounds, and arylamide compounds. Specifically, C.I. pigment yellow 12, 13, 14, 15, 17, 62, 74, 83, 93, 94, 95, 109, 110, 111, 128, 129, 147, 155, 168, and 180 are suitably used.

Examples of a magenta colorant include the following: condensed azo compounds, diketopyrrolopyrrole compounds, anthraquinone compounds, quinacridone compounds, basic dye lake compounds, naphthol compounds, benzimidazolone compounds, thioindigo compounds, and perylene compounds. Specifically, C.I. pigment red 2, 3, 5, 6, 7, 23, 48:2, 48:3, 48:4, 57:1, 81:1, 122, 144, 146, 166, 169, 177, 184, 185, 202, 206, 220, 221, and 254 are suitably used.

Examples of a cyan colorant include the following: copper phthalocyanine compound and their derivatives, anthraquinone compounds, and basic dye lake compounds. Specifically, C.I. pigment blue 1, 7, 15, 15:1, 15:2, 15:3, 15:4, 60, 62, and 66 are suitably used.

The colorant is selected in consideration of the hue angle, chroma, lightness, lightfastness, OHP transparency, and dispersibility in the toner.

The content of colorant is preferably 1.0 parts by mass to 20.0 parts by mass and is more preferably 2.0 parts by mass to 10.0 parts by mass with respect to 100.0 parts by mass of binder resin. In a case where a magnetic particle is used as a colorant, the content thereof is preferably 40.0 parts by mass to 150.0 parts by mass with respect to 100.0 parts by mass of binder resin.

### Charge Control Agent

The toner particle may be caused to contain a charge control agent as needed. In addition, the charge control agent may be externally added to the toner particle. It is possible to stabilize charge characteristics and to control the optimal amount of triboelectric charge in accordance with a development system by the charge control agent being blended therein.

As the charge control agent, known charge control agents can be used, and in particular, charge control agents that bring about high charging speeds and can stably maintain specific amounts of charge.

Examples of the charge control agent that controls the toner to be negatively charged include the following:
organometallic compounds and chelate compounds are effective, and examples thereof include monoazo metallic compounds, acetylacetone metallic compounds, and aromatic oxycarboxylic acid-based, aromatic dicarboxylic acid-based, oxycarboxylic acid-based and dicarboxylic acid-based metallic compounds.

Examples of the charge control agent that controls the toner to be positively charged include the following:
nigrosine, quaternary ammonium salts, metal salts of higher fatty acids, diorganotin borates, guanidine compounds, and imidazole compounds.

The content of charge control agent is preferably from 0.01 parts by mass to 20.0 parts by mass and is more preferably from 0.5 parts by mass to 10.0 parts by mass with respect to 100.0 parts by mass of toner particle.

### External Additive

The toner particle may be directly used as a toner, or may be used as a toner after an external additive or the like is mixed as necessary and is caused to adhere to the toner particle surface.

Examples of external additives include inorganic fine particles selected from the group consisting of silica fine particles, alumina fine particles, and titania fine particles or complex oxides thereof. Examples of complex oxides include silica aluminum fine particles and strontium titanate fine particles.

The content of the external additive with respect to 100 parts by mass of the toner particles is preferably from 0.01 parts by mass to 8.0 parts by mass and more preferably from 0.1 parts by mass to 4.0 parts by mass.

### Number Average Particle Diameter

The number average particle diameter of the toner is, for example, 4.0 μm to 12.0 μm and is preferably 4.0 μm to 10.0 μm. Within this range, it becomes easy to achieve more satisfactory low temperature fixability. The number average particle diameter of the toner is more preferably 4.5 μm to 9.0 μm and is further preferably 5.0 m to 8.0 μm.

### Manufacturing Method

Although the toner particle may be manufactured by any of known methods such as a suspension polymerization method, an emulsion aggregation method, a dissolution suspension method, a grinding method within the range of the configuration of this case, the toner particle is preferably manufactured by the suspension polymerization method.

The toner particle is preferably suspension-polymerized toner particle. The suspension polymerization method will be described in detail.

For example, a crystalline vinyl resin synthesized in advance is added to a mixture of each polymerizable monomer that may form an amorphous vinyl resin. As necessary, other materials such as an amorphous polyester resin, a colorant, a wax, a charge control agent, and the like are added and are uniformly dissolved or dispersed to prepare a polymerizable monomer composition.

Then, the polymerizable monomer composition is dispersed in an aqueous medium using a stirrer or the like to prepare a suspended particle of the polymerizable monomer composition. Then, the polymerizable monomer contained in the particle is polymerized with an initiator or the like to thereby obtain the toner particle.

A specific amount of each polymerizable monomer reacts with the crystalline vinyl resin polymerized in advance by using the hydrogen abstraction reaction at the time of the polymerization reaction, and it becomes easy to control the crystalline vinyl resin to have desired physical properties.

After polymerization of the toner particle ends, a cooling process of controlling the position where minute domains of the crystalline material are present and the sizes thereof, and/or a holding (annealing) process of controlling a level of crystallinity of the crystalline material may be included as needed.

In the present invention, the cooling process and the holding (annealing) process are preferably included from the viewpoint of effectively forming the domains including the ester wax W1 as a main component in the amorphous phase.

It is also preferable to raise the speed of cooling from the temperature at the time of the end of the polymerization reaction to the temperature after the cooling. Specifically, the cooling speed is preferably 10° C./min to 350° C./min and is more preferably 30° C./min to 200° C./min.

Also, the cooling start temperature in the cooling process is preferably 70° C. to 100° C. Furthermore, the annealing temperature in the holding (annealing) process is preferably 45° C. to 65° C. Examples of an annealing time include 1 hour to 10 hours and 2 hours to 8 hours.

After the annealing process for the toner particle ends, filtering, washing, and drying may be performed by known methods, and as necessary, an external additive may be added thereto to thereby obtain the toner.

As a polymerization initiator, a known polymerization initiator can be used.

Examples thereof include: azo-based or diazo-based polymerization initiators such as 2,2′-azobis-(2,4-dimethylvaleronitrile), 2,2′-azobisisobutyronitrile, 1,1′-azobis(cyclohexane-1-carbonitrile), 2,2′-azobis-4-methoxy-2,4-dimethylvaleronitrile, and azobisisobutyronitrile; and peroxide-based polymerization initiators such as benzoyl peroxide, t-butyl peroxy 2-ethylhexanoate, t-butyl peroxypivalate, t-butyl peroxyisobutyrate, t-butyl peroxyoctoate, t-butyl peroxyneodecanoate, methyl ethyl ketone peroxide, diisopropyl peroxydicarbonate, cumene hydroperoxide, 2,4-dichlorobenzoyl peroxide, and lauroyl peroxide.

Polymerization initiators which are likely to cause a hydrogen abstraction reaction are peroxide-based polymerization initiators and are preferably used. Among these, initiators such as t-butyl peroxy 2-ethylhexanoate, t-butyl peroxypivalate, t-butyl peroxyisobutyrate, t-butyl peroxyoctoate, and t-butyl peroxyneodecanoate are more preferably used.

The temperature of the polymerization reaction is preferably from 15° C. to 25° C. with respect to a ten-hour half-life temperature of the initiator. Within the above-described range, the hydrogen abstraction reaction is likely to appropriately occurs, and it becomes easy to control the crystalline vinyl resin to have desired physical properties.

In addition, a known chain transfer agent and polymerization inhibitor may be used.

The aqueous medium may contain an inorganic or organic dispersion stabilizer. As the dispersion stabilizer, known dispersion stabilizers can be used.

Examples of inorganic dispersion stabilizers include phosphates such as hydroxyapatite, tricalcium phosphate, dicalcium phosphate, magnesium phosphate, aluminum phosphate, and zinc phosphate; carbonates such as calcium carbonate and magnesium carbonate; metal hydroxides such as calcium hydroxide, magnesium hydroxide, and aluminum hydroxide; sulfates such as calcium sulfate and barium sulfate; calcium metasilicate; bentonite; silica; and alumina.

On the other hand, examples of the organic dispersion stabilizers include polyvinyl alcohol, gelatin, methyl cellulose, hydroxypropyl methylcellulose, ethyl cellulose, sodium salts of carboxymethylcellulose, polyacrylic acid and its salts, and starch.

In a case where an inorganic compound is used as a dispersion stabilizer, a commercially available product may be directly used, or in order to obtain a finer particle, the above-described inorganic compound may be generated in an aqueous medium.

For example, in the case of calcium phosphate such as hydroxyapatite or tricalcium phosphate, a phosphate aqueous solution and a calcium salt aqueous solution may be mixed under high-speed stirring.

The aqueous medium may contain a surfactant. As the surfactant, known surfactants can be used. Examples thereof include anionic surfactants such as sodium dodecylbenzene sulfate and sodium oleate; cationic surfactants; amphoteric surfactants; and nonionic surfactants.

Calculation methods and measurement methods for various physical properties of the toner and the toner materials will be described below.

### Qualitative Method for Domains in Amorphous Phase in Cross Section of Toner

A method of confirming that the domains in the amorphous phase contain the ester wax W1 as a main component in a cross section of the toner particle is as follows. A thin sample to be used in STEM observation of the cross section of the toner particle, which will be described later, is analyzed by using AFM-IR, and comparison with a STEM image is performed.

A method of performing qualification by using the AFM-IR will be described.

The toner is embedded with a visible light curable resin (D-800, manufactured by New EM Co., Ltd.) in a manner that the toner is dispersed as much as possible, and cut into a thickness of 100 nm with an ultrasonic ultramicrotome (UC7, manufactured by Leica Microsystems Inc.). The thin sample is placed on a dedicated grid for STEM observation, which will be described later.

The thin sample produced by the above-mentioned method is measured using nano-IR2 (manufactured by Anasys Instruments Limited). From the shape distribution measurement, the locations of the domains are specified, and a cantilever is caused to approach places directly above the domains to thereby obtain an IR spectrum. The measurement range is, for example, 1,900 cm⁻¹ to 900 cm⁻¹, and the resolution is 2 cm⁻¹. It is possible to qualify the domains by comparing the obtained spectrum with an IR spectrum of an isolated product of the ester wax W1 measured in advance. In a case where a characteristic peak appearing only in the isolated product of the ester wax W1 measured in advance can be also detected from the IR spectrum of the domains, it is determined that “the domains include the ester wax W1 as a main component”.

Next, presence states of the crystalline phase and the amorphous phase in the cross section of the toner are checked by observing the cross section of the toner using a scanning transmission electron microscope. The cross section of the toner is observed after performing ruthenium staining. In other words, the cross-sectional image of the toner particles according to the present disclosure is a cross-sectional image of the ruthenium stained toner particles.

The thin sample after analysis by the AFM-IR is stained for 15 minutes in a RuO4 gas 500 Pa atmosphere using a vacuum staining device (VSC4R1H manufactured by Filgen, Inc.), and a STEM image is acquired using a scanning transmission electron microscope (JEM2800, JEOL Ltd.). Since a difference occurs in degree of staining between the crystalline resin and the amorphous resin under the above-described staining conditions, the presence states of the crystalline phase and the amorphous phase and the ester wax W1 domains in the amorphous phase can thus be checked on the basis of the differences in contrast. As observation conditions, an acceleration voltage is set to 200 kV, a STEM probe size is set to 1 nm, an image size is set to 1024 pixels×1024 pixels, the magnification is set to 30000, and a bright field (STEM-BF) image is acquired.

At this time, cross sections analyzed by the AFM-IR by the above-described method are selected for the toner particles from which section images are to be acquired, the number average particle diameter of the toner is measured by a measurement method, which will be described later, and ten toner particles having long-axis diameters of 0.8 times to 1.1 times with respect to the number average particle diameter are selected. In addition, the image is acquired so as to avoid two or more toners in the field of view of one image.

In a case where the entire periphery of the domains that have been qualified by the analysis by the AFM-IR and include the ester wax W1 as a main component is the amorphous phase in the observation of the cross sections of the toner particles, it is determined that the target domains are domains that are present in the amorphous phase that includes the ester wax W1 as a main component.

### Methods of Measuring Number Nd of Domains of Ester Wax W1, Number Average Value d of Long Diameter, and Area Sw in Section of Toner

Calculation is performed by analyzing, by using Image J, the STEM image of the cross section of each toner particle obtained by the method of checking the domains that are present in the amorphous phase that includes the ester wax W1 as a main component.

First, an image scale is set. The scale is set by “Set Scale” in an “Analyze” menu using an image scale bar.

Next, “ROI Manager” is selected from “Tools” in the “Analyze” menu, and “Show All” and “Labels” are checked in a newly opened “ROI Manager” window. Subsequently, an elliptical tool (Elliptical selections) in the tool bar is used to approximate a domain of the ester wax W1 in the amorphous phase by an ellipse. In this state, “Add” in the “ROI Manager” window is selected.

Similarly, a domain that is different from the selected domain is approximated by an ellipse, and “Add” is selected. If “Measure” in the “ROI Manager” window is selected after the operation is repeated for all the domains in the image, then analysis is performed. The number of domains per toner particle is calculated through the above operations. The average value nd of the numbers of domains per toner particle is calculated by performing this process on the ten toner particles and averaging the numbers.

The long axis of each domain is acquired from a newly opened “Results” window, and a number average value d is calculated.

The number average value d calculated by the above method is divided by the number average particle diameter D of the toner measured by the following method to thereby calculate d/D.

In addition, the area of each domain is acquired from the same “Results” window and is added up to thereby obtain Sw.

Method of Measuring Area Ratio S1 of Amorphous Phase with Respect to Area of Crystalline Phase in Section of Toner Particle

The above-described area ratio is calculated by analyzing, using image processing software Image J (developed by Wayne Rashand), the STEM image of the section of each toner particle obtained by the above-described method. A brightness histogram is used for the calculation. The brightness histogram is a brightness histogram obtained by measuring a brightness spectrum of 256 gradations in the image obtained through the image analysis of the section of the toner particle. The FIGURE illustrates an example of the brightness histogram of 256 gradations obtained from the cross-sectional image of the toner 1. The specific procedure will be presented below.

First, a bright-field image to be analyzed is converted into 8 bits from “Type” in an “Image” menu.

Next, the image scale is set. The scale is set by “Set Scale” in an “Analyze” menu using an image scale bar. From the Filters in the Process menu, the Median diameter is set to 2.0 pixels to reduce the image noise.

Next, a range to be analyzed is designated only in the region inside the contour of the toner particle. In this regard, the interface between the above-described visible light curable resin and the toner particle cross section is regarded as a boundary for the contour of the toner particle. The outside of the range to be analyzed is erased by the Clear Outside of the Edit menu.

The area of the entire cross section is calculated by “Measure” in the “Analyze” menu.

Next, the proportion of the area of the amorphous phase in the entire cross section is calculated. Once “Histogram” in the “Analyze” menu is selected, then a brightness histogram having two peaks originated from the crystalline phase and the amorphous phase, respectively, is displayed. “List” is displayed to check a pixel value PV when the pixel count is the smallest between the two peaks. An example of the value V is illustrated in the FIGURE.

In the present disclosure, the crystalline phase and the amorphous phase are defined as follows. A STEM image of a cross section of the toner particle is analyzed by using image processing software, and a brightness histogram of 256 gradations is obtained. The pixel value at the location where the pixel count is the smallest between the peak of the crystalline resin and the peak of the amorphous resin in the obtained brightness histogram is regarded as the value V.

The part having a pixel value corresponding to brightness of from the value V to 255 in the section of the toner particle is the “amorphous phase that includes the amorphous resin as a main component”.

“Threshold” is selected from “adjust” in the “Image” menu, the location of an “up” bar is set to the pixel value V checked as described above, the location of a “down” bar is set to 255 (maximum), and “apply” is selected, thereby selecting only the amorphous phase part. A total area of the amorphous phase is calculated by checking “Summarize” in “Analyze Particles” in the “Analyze” menu.

Furthermore, the area of the crystalline phase that includes the crystalline vinyl resin as a main component is calculated by subtracting the total value Sw of the area of the amorphous phase and the area of the domains that are obtained by the above-described method and are present in the amorphous phase that includes the ester wax W1 as a main component from the area of the entire cross section. Finally, the area ratio S1(%) of the amorphous phase with respect to the area of the crystalline phase in the cross section of the toner is calculated by dividing the area of the amorphous phase by the area of the crystalline phase.

### Principle of Ruthenium Staining

In a case where the cross section of the toner particle is stained with ruthenium, and the crystalline resin component is stained with ruthenium as compared with the amorphous resin component, which leads to clear contrast and easiness in observation of the cross section of the toner particle. This is because RuO4 has a strong oxidation ability and oxidizes long chain alkyl and alkylene which enhance the crystallinity, and as a result, the crystalline resin component is stained more strongly than the amorphous resin component.

Moreover, since more ruthenium atoms are present as the crystallinity of the resin component is higher, and electron beams are less likely to be transmitted as more ruthenium atoms are present, the resin component with higher crystallinity is observed to be stained more strongly in the electron microscope observation image. On the contrary, the amorphous resin component is observed to be weakly stained or not to be stained. On the basis of this fact, it is possible to determine that the strongly stained part is a part containing the crystalline resin while the part that is weakly stained or that is not stained is a part containing the amorphous resin.

### Method of Measuring Number Average Particle Diameter

The number average particle diameter of the toner is calculated as follows. A particle counting analyzer “CDA-1000X” (manufactured by SYSMEX Corp.) in accordance with a pore electrical resistance method, including an aperture tube of 100 m, is used as a measurement apparatus. Appended dedicated software “CDA-1000X (manufactured by SYSMEX Corp.)” is used for setting the measurement conditions and analyzing measurement data.

For example, “CELLPACK” (manufactured by SYSMEX CORPORATION) can be used for an aqueous electrolytic solution for use in the measurement.

Note that before performing measurement and analysis, dedicated software is set as follows.

On the “measurement condition setting” screen of the dedicated software, the total count number is set to 50,000, the number of repeated measurements is set to 1, and the measurement mode is set to the total count (no limit).

Specific measurement methods are as follows.
(1) 150 mL of an electrolyte aqueous solution is put into a special glass round-bottom beaker, which is set on a sample stage, and stirred with a stirring propeller at 500 rpm. Then, the user clicks “blank check measurement” on the dedicated software to start the measurement, and confirms that the count number is less than 500. When the count number is 500 or more, the beaker and the aperture are washed repeatedly.
(2) 30 mL of the electrolyte aqueous solution is put into a 100 mL flat-bottomed glass beaker. 0.3 mL of a diluted solution prepared by diluting “Contaminon N” (a 10 mass % aqueous solution of a neutral detergent with pH 7 for washing precision measurement instruments, containing a nonionic surfactant, an anionic surfactant, and an organic builder, commercially available from Wako Pure Chemical Industries, Ltd.) three mass times by weight with deionized water is added as a dispersing agent thereto.
(3) An ultrasonic disperser with an electrical output of 120 W “Ultrasonic Dispension System Tetra150” (commercially available from Nikkaki Bios Co., Ltd.), which incorporates two oscillators with an oscillation frequency of 50 kHz and with phases shifted by 180 degrees, is prepared. 3.3 L of deionized water is put into a water tank of the ultrasonic disperser, and 2 mL of Contaminon N is added to this water tank.
(4) The beaker in (2) is set in a beaker fixing hole of the ultrasonic disperser, and the ultrasonic disperser is operated. Then, the height position of the beaker is adjusted so as to maximize the resonance state of the liquid surface of the aqueous electrolytic solution in the beaker.
(5) While the aqueous electrolytic solution in the beaker in (4) is irradiated with ultrasonic waves, 10 mg of the toner is added little by little and dispersed. Then, the ultrasonic dispersion treatment is continued for an additional 60 seconds. Furthermore, for the ultrasonic dispersion, the water temperature in the water tank is appropriately adjusted to be in a range from 10° C. to 40° C.
(6) In the round-bottom beaker in (1) placed in the sample stand, the electrolyte aqueous solution in (5) in which the toner is dispersed using a pipette is added dropwise, and the measurement concentration is adjusted to 6%. Then, the measurement is performed until the number of measurement particles reaches 50,000.
(7) The measurement data is analyzed using a dedicated software attached to the device, and the number average particle diameter is calculated.
   Separation of Toner Particle from Toner

By the following method, the toner particle obtained by separating the toner particle and the external additive can be used for each analysis.

160 g of sucrose (commercially available from Kishida Chemical Co., Ltd.) is added to 100 mL of deionized water and dissolved in a hot water bath to prepare a sucrose concentrated solution. 31 g of the sucrose concentrated solution and 6 mL of Contaminon N (a 10 mass % aqueous solution of a neutral detergent with pH 7 for washing precision measurement instruments, containing a nonionic surfactant, an anionic surfactant, and an organic builder, commercially available from Wako Pure Chemical Industries, Ltd.) were put into a centrifugation tube to prepare a dispersion. To this dispersion, 1 g of the toner is added, and the toner lump is loosened with a spatula or the like.

The centrifuge tube is set in “KM Shaker” (model: V.SX) manufactured by IWAKI INDUSTRY CO., LTD., and shaken under the condition of 350 reciprocations per minute for 20 minutes. After the shaking, the solution is transferred into a glass tube (50 mL) for a swing rotor, and centrifuged under the condition of 3,500 rpm for 30 minutes in a centrifuge (H-9R manufactured by KOKUSAN Co., Ltd.).

In the glass tube after the centrifugation, the toner particle is present in the uppermost layer, whereas the external additives such as silica fine particles are present on the aqueous solution side of the lower layer. The toner particle on the upper layer is collected, filtered, and washed by flushing them with 2 L of deionized water heated to 40° C., and the washed toner particle is extracted.

Separation of Crystalline Vinyl Resin, Amorphous Vinyl Resin, Amorphous Polyester Resin, and Ester Wax from Toner Particle and Measurement of Content Rates

1.5 g of toner is weighed, is put in a cylindrical filter paper (trade name: No. 86R, size: 28 mm×100 mm, manufactured by Advantec Toyo Kaisha, Ltd.), and is then set in a Soxhlet extractor. Extraction is performed for 18 hours with the use of 200 mL of chloroform as a solvent, and at that time, the extraction is performed at such a reflux speed that the extraction cycle of the solvent is once every five minutes. The chloroform is sufficiently distilled off with an evaporator from the extracted chloroform-soluble content to thereby separate the resin component such as the binder resin and the wax mixture, which are the chloroform-soluble content, from the toner.

In the separation of the binder resin and the wax, a component with a molecular weight of equal to or less than 2000 is separated as a wax by recycle HPLC. A measurement method is presented below. First, the mixture of the resin component and the wax is dissolved in chloroform by the above-described method. Then, the obtained solution is filtered through a solvent-resistant membrane filter “MAISHORIDISC” (manufactured by Tosoh Corporation) with a pore diameter of 0.2 μm, thereby obtaining a sample solution. Further, the sample solution is adjusted such that the concentration of the component that is soluble in the chloroform is 1.0% by mass. The sample solution is used to perform measurement under the following conditions.
Device: LC-Sakura NEXT (commercially available from Japan Analytical Industry Co., Ltd.)
Column: JAIGEL2H, 4H (commercially available from Japan Analytical Industry Co., Ltd.)
Eluent: chloroform
Flow rate: 10.0 mL/min
Oven temperature: 40.0° C.
Sample injection amount: 1.0 mL

In the calculation of the molecular weight of the sample, a molecular weight calibration curve created using a standard polystyrene resin (for example, trade name “TSK standard polystyrene F-850, F-450, F-288, F-128, F-80, F-40, F-20, F-10, F-4, F-2, F-1, A-5000, A-2500, A-1000, and A-500” manufactured by Tosoh Corporation) is used.

From the thus obtained molecular weight curve, a component with a molecular weight of equal to or less than 2000 is repeatedly fractionated, and the resin component and the wax such as the ester wax W1 can thus be separated.

In a case where the toner particle contains the ester wax W2 in addition to the ester wax W1, it is possible to perform setting such that two peaks are detected by arranging the column type and measurement conditions for the above-described component with the molecular weight of equal to or less than 2000. It is possible to separate each of the two ester wax by setting the fractionation conditions such that a component originated from each peak can be separated.

The structure of the wax is qualified by analyzing the composition of the separated wax by the following method. Also, the mass of the separated ester wax W1 is measured, and the content M2 (parts by mass) of the ester wax W1 with respect to 100 parts by mass of crystalline vinyl resin is calculated from a rate of the crystalline vinyl resin, which will be described later.

The crystalline vinyl resin, the amorphous vinyl resin, and the amorphous polyester resin can be separated from the binder resin by the following method with a gradient polymer LC.

The binder resin separated by the above-described method is used as a sample and is adjusted with chloroform such that the sample concentration is 1.0% by mass, and a product obtained by filtering the solution with a 0.45 μm PTFE filter is subjected to measurement. The gradient polymer LC measurement conditions are shown below.
Apparatus: UITIMATE3000 (manufactured by Thermo Fisher Scientific)
Mobile phase: A: chloroform (HPLC), B: acetonitrile (HPLC)
Gradient: 2 minutes (A/B=0/100)→25 minutes (A/B=100/0) (Note that a gradient of a change in a mobile phase is set to a straight line.)
Flow velocity: 1.0 mL/min
Injection: 1.0% by mass×20 μL
Column: Tosoh TSKgel ODS (4.6 mmφ×150 mm×5 μm)
Column temperature: 40° C.
Detector: Corona charged particle detector (Corona-CAD) (manufactured by Thermo Fisher Scientific Inc.)

In a time-signal intensity (A) graph obtained in the measurement, the binder resin can be separated into three peaks depending on the polarity. Then, it is possible to perform separation into three kinds of resins by repeating the above-described measurement again and performing the fractionation at the timing corresponding to the valleys of the respective peaks. The crystalline vinyl resin, the amorphous vinyl resin, and the amorphous polyester resin are identified by analyzing the compositions of the separated resins by the following method. The masses of the separated resins are measured to calculate the rates of the crystalline vinyl resin, the amorphous vinyl resin, and the amorphous polyester resin in the binder resin.

The content rate M1 (% by mass) of the crystalline vinyl resin in the binder resin, the content rate M3 (% by mass) of the amorphous polyester resin in the binder resin, and the like are calculated from the rates obtained by the above-described method.

Composition Analysis Method for Monomer Unit (a) of Crystalline Vinyl Resin, Monomer Unit (b) of Amorphous Vinyl Resin, Monomer Unit (c) of Amorphous Polyester Resin, Ester Waxes W1 and W2, and Like

The compositions of the monomer unit (a) of the crystalline vinyl resin, the monomer unit (b) of the amorphous vinyl resin, the monomer unit (c) of the amorphous polyester resin, the ester waxes W1 and W2, and the like are analyzed by ¹H-NMR and ¹³C-NMR under the following conditions. The crystalline vinyl resin will be described as an example. As a measurement sample, the crystalline vinyl resin fractionated by the above method can be used.
Measurement device: FT NMR device JNM-EX400 (commercially available from JEOL Ltd.)
Measurement frequency: 400 MHz
Pulse Condition: 5.0 s
Frequency range: 10,500 Hz
Accumulation count: 64 times
Measurement temperature: 30° C.
Sample: 50 mg of measurement sample is put in a sample tube with an inner diameter of 5 mm, deuterated chloroform (CDCl₃) is added thereto as a solvent, this mixture is dissolved in a constant-temperature bath at 40° C., thereby preparing a sample. The thus obtained ¹H-NMR chart is analyzed to identify the structure of each monomer unit. Here, measurement of the content rate of the monomer unit (a) in the crystalline vinyl resin and the number of carbon atoms in the alkyl group will be described as an example.

In the obtained ¹H-NMR chart, a peak independent of peaks attributed to components of other monomer units is selected from among the peaks attributed to components of the monomer unit (a), and the integral value S1 of this peak is calculated. Integral values of the other monomer units contained in the crystalline vinyl resin are calculated in a similar manner.

In a case where the monomer units constituting the crystalline vinyl resin are the monomer unit (a) and one other monomer unit, the content rate of the monomer unit (a) is obtained using the above-described integral value S1 and the integral value S2 of the peak of the other monomer unit as follows. Here, n1 and n2 are the numbers of hydrogen atoms in the components to which the peak of interest for each site belongs.

$$The content of the monomer unit ( a ) ( mol \% ) = \{ ( S 1 / n 1 ) / ( ( S 1 / n 1 ) + ( S 2 / n 2 ) ) \} \times 100$$

Even in a case where there are two or more kinds of other monomer units, the content rate of the monomer unit (a) can be calculated in a similar manner (using S3 . . . Sx, n3 . . . nx).

Also, the number of carbon atoms in the alkyl group can be calculated from the integral ratio of proton peaks in the ¹H-NMR chart.

Note that in a case where a polymerizable monomer containing no hydrogen atom is used as a component other than vinyl groups, the measurement nucleus is set to ¹³C using ¹³C-NMR, measurement is performed in a single pulse mode, and calculation is performed in a similar manner as for ¹H-NMR.

The rate (mol %) of each monomer unit calculated by the above-described method is multiplied by the molecular weight of each monomer unit to thereby convert the content rate of each monomer unit into a value in units of % by mass. In this manner, the content rate (ratio J) of the monomer unit (a) with reference to the mass of the crystalline vinyl resin in the crystalline vinyl resin is calculated. For example, the following expression can be used for the calculation.

[The content rate of the monomer unit (a) with reference to the mass of the crystalline vinyl resin:ratio J (unit: % by mass) (the molecular weight of the monomer unit (a):M1, the molecular weight of the other monomer units: M2)]

$$Ratio J = \{ ( S 1 / n 1 ) \times M 1 / ( ( S 1 / n 1 ) \times M 1 + ( S 2 / n 2 ) \times M 2 ) \} \times 100 \qquad ( 7 )$$

Measurement is performed by using a similar method for the amorphous vinyl resin, the amorphous polyester resin, and the ester waxes W1 and W2 as well.

### Method of Measuring Molecular Weight of Crystalline Vinyl Resin

The molecular weight (weight average molecular weight Mw) of a THF soluble content in the crystalline vinyl resin is measured by gel permeation chromatography (GPC) as follows.

First, the crystalline vinyl resin is dissolved in tetrahydrofuran (THF) at room temperature for 24 hours. Then, the obtained solution is filtered through a solvent-resistant membrane filter “MAISHORIDISC” (manufactured by Tosoh Corporation) with a pore size of 0.2 μm, thereby obtaining a sample solution. It should be noted that the sample solution is adjusted so that the density of the component soluble in THF be 0.8% by mass. The sample solution is used to perform measurement under the following conditions.
Apparatus: HLC8120 GPC (detector: RI) (manufactured by Tosoh Corporation)
Column: Seven connected Shodex KF-801, 802, 803, 804, 805, 806, and 807 columns (manufactured by Showa Denko)
Eluent: Tetrahydrofuran (THF)
Flow rate: 1.0 ml/min
Oven temperature: 40.0° C.
Sample injection amount: 0.10 ml

In the calculation of the molecular weight of the sample, a molecular weight calibration curve created using a standard polystyrene resin (for example, trade name “TSK standard polystyrene F-850, F-450, F-288, F-128, F-80, F-40, F-20, F-10, F-4, F-2, F-1, A-5000, A-2500, A-1000, and A-500” manufactured by Tosoh Corporation) is used.

### EXAMPLES

Hereinafter, the present disclosure will be more specifically described on the basis of examples, which do not limit the present disclosure in any sense. It should be noted that unless otherwise particularly specified, “part(s)” are on a mass basis in the following formulations.

### Preparation of Amorphous Vinyl Resin Precursor 1

The following materials were put into a reaction container including a reflux cooling tube, a stirrer, a thermometer, and a nitrogen inlet tube under a nitrogen atmosphere.

100.0 parts of toluene
100.0 parts of a monomer composition
   (the monomer composition is a mixture of the following monomers in the following proportions)
(60.0 parts of behenyl acrylate)
(15.0 parts of styrene)
(20.0 parts of acrylonitrile)
(5.0 parts of n-butyl acrylate)
0.5 parts of polymerization initiator t-butyl peroxypivalate (PERBUTYL PV, commercially available from NOF Corporation)

Heating was performed to 70° C. while stirring was performed inside the reaction container at 200 rpm, and a polymerization reaction was performed for 12 hours to thereby obtain a solution in which the polymer of the monomer composition was dissolved in toluene. Subsequently, the temperature of the solution was lowered down to 25° C., and then, the solution was put into 1000.0 parts of methanol while stirred to thereby precipitate a methanol-insoluble content. The obtained methanol-insoluble content was separated by filtration, was further washed with methanol, and was then vacuum-dried at 40° C. for 24 hours to thereby obtain a crystalline vinyl resin precursor 1. Physical properties of the crystalline vinyl resin precursor 1 are shown in Table 1.

### Preparation of Amorphous Vinyl Resin Precursor 2

A crystalline vinyl resin precursor 2 was prepared in a completely similar manner other than that the kinds of the monomer compositions and the amounts of addition were changed to those in Table 1 in the preparation of the crystalline vinyl resin precursor 1. Physical properties of the crystalline vinyl resin precursor 2 are shown in Table 1.

### Preparation of Amorphous Vinyl Resin Precursor 3

The following materials were put into a reaction container equipped with a reflux cooling tube, a stirrer, a thermometer, and a nitrogen inlet tube under a nitrogen atmosphere.
100.0 parts of toluene
100.0 parts of behenyl acrylate
10.0 parts of 2,2′-azobis(2,4-dimethylvaleronitrile) (V-65, manufactured by Wako Pure Chemical Industries, Ltd.)

Heating was performed to 60° C. while stirring was performed inside the reaction container at 200 rpm, and a polymerization reaction was performed for 12 hours to thereby obtain a solution in which the polymer of the monomer composition was dissolved in toluene. Subsequently, the temperature of the solution was lowered down to 25° C., and then, the solution was put into 1000.0 parts of methanol while stirred to thereby precipitate a methanol-insoluble content. The obtained methanol-insoluble content was separated by filtration, was further washed with methanol, and was then vacuum-dried at 40° C. for 24 hours to thereby obtain a crystalline vinyl resin precursor 3. Physical properties of the crystalline vinyl resin precursor 3 are shown in Table 1.

TABLE 1

| Crystalline | | | | | | | | | |
|---|---|---|---|---|---|---|---|---|---|
| vinyl resin | | | Other | | Other | | Other | | Molecular |
| precursor | Monomer (a) | | monomer 1 | | monomer 2 | | monomer 3 | | weight |
| No. | Type | Part | Type | Part | Type | Part | Type | Part | Mw |
| 1 | Behenyl acrylate | 60 | Styrene | 15 | Acrylonitrile | 20 | Butyl acrylate | 5 | 30200 |
| 2 | Behenyl acrylate | 80 | Styrene | 10 | Acrylonitrile | 5 | Butyl acrylate | 5 | 31900 |
| 3 | Behenyl acrylate | 100 | None | — | None | — | None | — | 22000 |

The molecular weight Mw is a weight average molecular weight.

### Preparation of Amorphous Vinyl Resin 1

The following materials were put into a reaction container equipped with a reflux cooling tube, a stirrer, a thermometer, and a nitrogen inlet tube under a nitrogen atmosphere.
80.0 parts of styrene
20.0 parts of n-butyl acrylate
3.0 parts of methyl methacrylate
1.5 parts of methacrylic acid
100.0 parts of toluene
10.0 parts of t-butyl peroxypivalate

The inside of the container was stirred at 200 revolutions per minute, heating was performed to 80° C., and stirring was performed for 10 hours. Furthermore, heating was performed to 95° C., stirring was performed for 8 hours, and the solvent was removed, thereby obtaining the amorphous vinyl resin 1.

### Preparation of Amorphous Polyester Resin 1

1000 parts by mass of bisphenol A-propylene oxide 2 mol adduct
270 parts by mass of isophthalic acid
250 parts by mass of dodecenylsuccinic acid

The monomers were added to a flask equipped with a stirring device, a nitrogen inlet tube, a temperature sensor, and a rectification column, and the temperature was raised to 195° C. in 1 hour to confirm that the inside of the reaction system was uniformly stirred. To 100 parts by mass of these monomers, 1.2 parts by mass of tin distearate was added. The temperature was further raised from 195° C. to 240° C. over 5 hours while generated water was distilled off, and a dehydration condensation reaction was further performed at 240° C. for 2 hours.

Next, the temperature was lowered down to 190° C., 20 parts by mass of trimellitic anhydride was gradually added, and the reaction was continued at 190° C. for 1 hour, thereby obtaining an amorphous polyester resin 1. Physical properties of the obtained amorphous polyester resin 1 are shown in Table 2.

### Preparation of Amorphous Polyester Resins 2 to 4

Amorphous polyester resins 2 to 4 were prepared in a completely similar manner other than that the kinds and the amounts of acid monomers and alcohol monomers used were changed to those in Table 2 in the preparation of the amorphous polyester resin 1. Physical properties of the amorphous polyester resins 2 to 4 are shown in Table 2.

TABLE 2

| | | | | | | | Resin physical properties | | |
|---|---|---|---|---|---|---|---|---|---|
| Amorphous | Alcohol monomer | | Acid monomer | | | | | | Molecular |
| polyester | BPA-2PO | BPA-2EO | IPA | Unit (c) monomer | | TMA | Tg | Acid value | weight |
| resin No. | Part | Part | Part | Part | Type of R₁ | Part | [° C.] | [mgKOH/g] | [Mw] |
| 1 | 1000 | 0 | 270 | 250 | Dodecenyl group | 20 | 65.7 | 5.3 | 13800 |
| 2 | 1000 | 0 | 350 | 100 | Dodecenyl group | 20 | 68.4 | 5.2 | 9800 |
| 3 | 1000 | 0 | 400 | 50 | Dodecenyl group | 20 | 71.2 | 5.1 | 14200 |
| 4 | 700 | 300 | 450 | 0 | — | 20 | 71.8 | 5.3 | 15500 |

BPA-2PO: Bisphenol A-propylene oxide 2 mol adduct
BPA-2EO: Bisphenol A-ethylene oxide 2 mol adduct
IPA: Isophthalic acid
TMA: Trimellitic anhydride

### Example 1

### Production of Toner by Suspension Polymerization Method

### Production of Toner Particle 1

56.2 parts of styrene
15.8 parts of n-butyl acrylate
6.5 parts of colorant (pigment blue 15:3)

A mixture including the above materials was prepared. The mixture was put into an attritor (manufactured by Nippon Coke & Engineering Co., Ltd.), and dispersion was performed using zirconia beads with a diameter of 5 mm at 200 rpm for 2 hours, thereby obtaining a raw material dispersed solution.

On the other hand, 735.0 parts of deionized water and 16.0 parts of trisodium phosphate (12-hydrate) were put into a container including a high-speed stirring device Homomixer (commercially available from Primix Corporation) and a thermometer, and heated to 60° C. with stirring at 12,000 rpm. A calcium chloride aqueous solution in which 9.0 parts of calcium chloride (dihydrate) was dissolved in 65.0 parts of deionized water was added thereto, and while maintaining the temperature at 60° C., the mixture was stirred at 12,000 rpm for 30 minutes. 10% hydrochloric acid was added thereto to adjust the pH to 6.0, and thereby an aqueous medium in which an inorganic dispersion stabilizer containing hydroxyapatite was dispersed in water was obtained.

Subsequently, the raw material-dispersed solution was transferred to a container including a stirring device and a thermometer, and heated to 60° C. with stirring at 100 rpm.
Crystalline vinyl resin precursor 1: 23.0 parts
Amorphous polyester resin 1: 5.0 parts
ethylene glycol dibehenate (ester wax W1): 9.0 parts
dipentaerythritol hexabehenate (ester wax W2): 5.0 parts

The above materials were added to the container and were stirred at 100 rpm for 30 minutes while the temperature was maintained at 60° C. 8.0 parts of t-butyl peroxypivalate (PERBUTYL PV manufactured by NOF Corporation) as a polymerization initiator was then added thereto, and the mixture was further stirred for 1 more minute and was then added to an aqueous medium that was being stirred at 12000 rpm by the high-speed stirring device. While maintaining the temperature at 60° C., stirring was continued at 12,000 rpm for 20 minutes by the high-speed stirring device to obtain a granulation liquid.

The granulation liquid was transferred to a reaction container including a reflux cooling tube, a stirrer, a thermometer, and a nitrogen inlet tube and heated to 76° C. under a nitrogen atmosphere with stirring at 150 rpm. While maintaining the temperature at 76° C., a polymerization reaction was performed at 150 rpm for 6 hours to obtain a toner particle-dispersed solution.

Subsequently, the suspension solution was cooled at a speed of 100° C./min from 76° C. to 50° C. in a cooling process, and thermal treatment was then performed for 5 hours while 50° C. was maintained. Then, while maintaining stirring, dilute hydrochloric acid was added until the pH reached 1.5 to dissolve the dispersion stabilizer. The solid content was separated through filtration, was sufficiently washed with deionized water, and was then vacuum-dried at 30° C. for 24 hours, thereby obtaining a toner particle 1.

### Preparation of Toner 1

2.0 parts of silica fine particles (hydrophobized with hexamethyldisilazane, the number average particle diameter of primary particles: 10 nm, BET specific surface area: 170 m²/g) as an external additive were added to 98.0 parts of the toner particle 1, and the mixture was mixed using a Henschel mixer (manufactured by Nippon Coke & Engineering Co., Ltd.) at 3000 rpm for 15 minutes, thereby obtaining a toner 1. Physical properties of the obtained toner 1 are shown in Tables 4-1 and 4-3.

Also, the toner 1 was evaluated using a method described later in “Method of Evaluating Toner”. The evaluation results are shown in Table 5-1.

### Examples 2 to 61

Toner particles 2 to 61 were obtained in a completely similar manner other than that the kinds and amounts of addition of crystalline vinyl resin precursors, polymerizable monomers, and amorphous polyester resins used, kinds and amounts of the ester waxes W1 and W2, polymerization reaction temperatures, and temperature lowering speeds in the cooling process were changed to those in Tables 3-1, 3-2, 3-3 and 3-4 in Example 1.

In addition, external addition was performed in the same manner as in Example 1 to obtain toners 2 to 61. Physical properties of the toners are shown in Tables 4-1, 4-2, 4-3 and 4-4 and evaluation results thereof are shown in Tables 5-1 and 5-2.

### Example 62

### Preparation of Crystalline Resin Dispersed Solution 1

Toluene: 300.0 parts
Crystalline vinyl resin precursor 1: 100.0 parts

The above materials were weighed, mixed, and dissolved at 90° C., thereby obtaining a toluene solution 1.

Separately, 5.0 parts by mass of sodium dodecylbenzenesulfonate and 10.0 parts by mass of sodium laurate were added to 700.0 parts by mass of deionized water, and the mixture was heated at 90° C. and was dissolved. Then, the toluene solution 1 and the aqueous solution were mixed together, and the mixture was stirred at 7000 rpm using an ultra-high speed stirring device T.K. Robomix (manufactured by Primix). Furthermore, the mixture was emulsified under a pressure of 200 MPa using a high-pressure impact disperser nanomizer (manufactured by Yoshida Kikai Kogyo Co., Ltd.). Thereafter, toluene was removed by using an evaporator, and the concentration was adjusted with deionized water, thereby obtaining a crystalline resin dispersed solution 1 in which the concentration of the crystalline resin 1 fine particles was 20% by mass.

A dynamic light scattering particle size distribution analyzer Nanotrac UPA-EX150 (manufactured by Nikkiso Co., Ltd.) was used to measure the 50% particle diameter (D50) of the crystalline resin 1 fine particles on a volume dispersion basis, which was 0.40 μm.

### Preparation of Amorphous Polyester Resin Dispersed Solution 1

Toluene: 300.0 parts
Amorphous polyester resin 1: 100.0 parts

The above materials were weighed, mixed, and dissolved at 90° C., thereby obtaining a toluene solution 2.

Separately, 5.0 parts by mass of sodium dodecylbenzenesulfonate and 10.0 parts by mass of sodium laurate were added to 700.0 parts by mass of deionized water, and the mixture was heated at 90° C. and was dissolved. Then, the toluene solution 2 and the aqueous solution were mixed together, and the mixture was stirred at 7000 rpm using an ultra-high speed stirring device T.K. Robomix (manufactured by Primix). Furthermore, the mixture was emulsified under a pressure of 200 MPa using a high-pressure impact disperser nanomizer (manufactured by Yoshida Kikai Kogyo Co., Ltd.). Thereafter, toluene was removed by using an evaporator, and the concentration was adjusted with deionized water, thereby obtaining an amorphous polyester resin dispersed solution 1 in which the concentration of the amorphous polyester resin fine particles was 20% by mass.

A dynamic light scattering particle size distribution analyzer Nanotrac UPA-EX150 (manufactured by Nikkiso Co., Ltd.) was used to measure the 50% particle diameter (D50) of the amorphous polyester resin fine particles on a volume dispersion basis, which was 0.38 μm.

### Preparation of Amorphous Vinyl Resin Dispersed Solution 1

780.0 parts of styrene
220.0 parts of n-butyl acrylate
6.0 parts of dodecyl mercaptan

A mixture obtained by mixing and dissolving the above materials was dispersed and emulsified in a mixture obtained by dissolving 20.0 parts of anionic surfactant Nurex Paste H (manufactured by NOF Corporation) in 1300.0 parts of deionized water in a flask. 200.0 parts of deionized water with 20.0 parts of ammonium persulfate dissolved therein was added to the mixture while the mixture was stirred for ten minutes, nitrogen purge was performed, heating was then performed until the temperature of the content became 70° C., and emulsion polymerization was carried out for 6 hours. Thereafter, the reaction solution was cooled to a room temperature, and the concentration thereof was adjusted with deionized water, thereby producing an amorphous vinyl resin dispersed solution 1 in which the concentration of the amorphous vinyl resin fine particles was 20% by mass.

A dynamic light scattering particle size distribution analyzer Nanotrac UPA-EX150 (manufactured by Nikkiso Co., Ltd.) was used to measure the 50% particle diameter (D50) of the amorphous vinyl resin fine particles on a volume dispersion basis, which was 0.35 μm.

### Preparation Wax Dispersed Solution

100.0 parts of ethylene glycol dibehenate (ester wax W1)
5.0 parts of anionic surfactant Neogen RK (manufactured by DKS Co., Ltd.)
395.0 parts of deionized water

The above materials were weighed and added to a mixing container equipped with a stirring device, were heated to 90° C., were circulated to CLEARMIX W-Motion (manufactured by M Technique Co., Ltd.), and were subjected to dispersion treatment for 60 minutes. The conditions of the dispersion treatment were as follows.
Rotor outer diameter: 3 cm
Clearance: 0.3 mm
Number of revolutions of rotor: 19,000 r/min
Number of revolutions of screen: 19,000 r/min

After the dispersion treatment, cooling was performed to 40° C. under cooling treatment conditions of a number of revolutions of a rotor of 1,000 r/min, a number of revolutions of a screen of 0 r/min, and a cooling speed of 10° C./min, thereby obtaining a release agent dispersed solution in which the concentration of the release agent fine particles was 20% by mass.

A dynamic light scattering particle size distribution analyzer Nanotrac UPA-EX150 (manufactured by Nikkiso Co., Ltd.) was used to measure the 50% particle diameter (D50) of the release agent fine particles on a volume dispersion basis, which was 0.15 μm.

### Preparation of Colorant Dispersed Solution

50 parts of colorant
(cyan pigment Pigment Blue 15:3, commercially available from Dainichiseika Color & Chemicals Mfg. Co., Ltd.)
7.5 parts of anionic surfactant Neogen RK (manufactured by DKS Co., Ltd.)
442.5 parts of deionized water

The above materials were weighed, mixed, dissolved, and dispersed for 1 hour using a high-pressure impact disperser nanomizer (manufactured by Yoshida Kikai Kogyo Co., Ltd.), thereby obtaining a colorant dispersed solution in which the colorant was dispersed and the concentration of the colorant fine particles was 10% by mass.

A dynamic light scattering particle size distribution analyzer Nanotrac UPA-EX150 (manufactured by Nikkiso Co., Ltd.) was used to measure the 50% particle diameter (D50) of the colorant fine particles on a volume dispersion basis, which was 0.20 μm.

### Production of Toner 62

Amorphous vinyl resin dispersed solution 1: 200.0 parts
Wax dispersed solution: 45.0 parts
Colorant dispersed solution: 65.0 parts
Ion exchanged water: 160.0 part

Each of the above-described materials was put in a round stainless flask and was then mixed. Subsequently, the mixture was dispersed at 5000 r/min for 10 minutes by using a homogenizer Ultra-Turrax T50 (manufactured by IKA). A 1.0% nitric acid aqueous solution was added to adjust the pH to 3.0, and then the mixed solution was heated to 58° C. using a stirring blade in a water bath for heating while appropriately adjusting a number of revolutions at which the mixed solution was stirred.

The volume average particle diameter of the formed aggregated particle was appropriately checked using Coulter Multisizer III, 275.0 parts of crystalline resin dispersed solution 1 and 25.0 parts of amorphous polyester resin dispersed solution 1 were added when an aggregated particle with a number average particle diameter of 3.0 m was formed, and the reaction was further continued. When the number average particle diameter reached 6.1 μm, pH was adjusted to 9.0 by using a 5% aqueous solution of sodium hydroxide. Thereafter, the mixture was heated to 75° C. while the stirring was continued. Then, the mixture was held at 75° C. for 1 hour to thereby fuse the aggregated particle.

Thereafter, the mixture was cooled to 45° C. at a speed of 100° C./min, and thermal treatment was carried out for 5 hours. After that, the mixture was cooled to 25° C., was filtered, was separated into solid and liquid, and was then washed with deionized water. The mixture was dried using a vacuum dryer after the washing ended, thereby obtaining a toner particle 62 with a number average particle diameter of 6.2 μm.

External addition was performed on the toner particle 62 similarly to Example 1, thereby obtaining a toner 62. Physical properties of the toner 62 are shown in Tables 4-2 and 4-4, and evaluation results thereof are shown in Table 5-2.

### Comparative Example 1

### Production of Comparative Toner 1

Crystalline vinyl resin precursor 3: 84.0 parts
Styrene: 100.0 parts
n-butyl acrylate: 25.0 parts
Amorphous vinyl resin 1: 10.0 parts
Pigment Blue 15:3 (manufactured by Dainichiseika Color & Chemicals Mfg. Co., Ltd.): 6.0 parts
Aluminum salicylate compound: 1.0 parts (Bontron E-88: manufactured by Orient Chemical Industries, Co., Ltd.)
Release agent paraffin wax: 9.0 parts (HNP-51: manufactured by Nippon Seiro Co., Ltd., melting point: 74° C.)
Toluene (SP value: 8.8): 100.0 parts

The above materials were dispersed using an attritor (manufactured by Mitsui Miike Kakoki Co., Ltd.), thereby obtaining a polymerizable monomer composition.

Also, 800 parts of deionized water and 15.5 parts of tricalcium phosphate were added into a container equipped with a high-speed stirring device TK-homomixer (manufactured by Tokushu Kika Kogyo Co., Ltd.), the number of revolutions was adjusted to 15000 revolutions/minute, warming was performed to 70° C., thereby obtaining a dispersion medium system.

After the polymerizable monomer composition was heated to 60° C., and the dissolution of the crystalline vinyl resin precursor 3 was confirmed, 6.0 parts of t-butyl peroxypivalate, which was a polymerization initiator, was added thereto, and this mixture was put into the above-described dispersion medium system. A granulation process was carried out for 20 minutes with 12,000 revolutions/min maintained in the high-speed stirring device. Thereafter, the stirrer was changed from the high-speed stirring device to a propeller stirring blade, and polymerization was carried out for 10.0 hours with the liquid temperature inside the container maintained at 70° C. while the mixture was stirred at 150 revolutions/min. After the polymerization process, the liquid temperature was raised to 95° C., and unreacted polymerizable monomer and toluene were distilled off. After the polymerization ended, the thus obtained polymer particle dispersed solution was cooled to 20° C. at an average speed of 0.6° C./min while stirred, and deionized water was added to adjust the concentration of the polymer particle in the dispersed solution to 20% by mass, thereby obtaining a toner particle dispersed solution.

A hydrochloric acid was added to the toner particle dispersed solution at a temperature of 25° C. until pH became 1.5, and the mixture was stirred for 2 hours. Furthermore, the mixture was sufficiently washed with deionized water, was then filtered, dried, and classified, thereby obtaining a comparative toner particle 1.

Then, 100.0 parts of comparative toner particle 1 was weighed, 1.0 part of silica fine particle having a number average particle diameter of 40 nm as a primary particle was added thereto, and the mixture was mixed using a Henschel mixer (manufactured by Mitsui Miike Kakoki Co., Ltd.), thereby obtaining a comparative toner 1. Physical properties of the obtained comparative toner 1 are shown in Tables 4-2 and 4-4, and evaluation results thereof are shown in Table 5-2.

### Comparative Examples 2 to 10

Comparative toner particles 2 to 10 were obtained in a completely similar manner other than that the kinds and the amounts of addition of crystalline vinyl resin precursors, polymerizable monomers, and amorphous polyester resins used, the kinds and the amounts of addition of the ester waxes W1 and W2, polymerization reaction temperatures, and temperature lowering speeds in the cooling process were changed to those in Tables 3-2 and 3-4 in Example 1.

In addition, external addition was performed similarly to Example 1, thereby obtaining comparative toners 2 to 10. Physical properties of the toners are shown in Tables 4-2 and 4-4, and evaluation results thereof are shown in Table 5-2.

TABLE 3-1

| | | Polymerizable | | Polymerizable | | | | | |
|---|---|---|---|---|---|---|---|---|---|
| | | monomer 1 | | monomer 2 | | CVRP | | APR | |
| E. | T. | | AoA | | AoA | | AoA | | AoA |
| No. | No. | Type | (part) | Type | (part) | Type | (part) | Type | (part) |
| 1 | 1 | Styrene | 56.2 | n-butyl acrylate | 15.8 | CVRP 1 | 23.0 | APR 1 | 5.0 |
| 2 | 2 | Styrene | 56.2 | n-butyl acrylate | 15.8 | CVRP 2 | 23.0 | APR 1 | 5.0 |
| 3 | 3 | Styrene | 56.2 | n-butyl acrylate | 15.8 | CVRP 3 | 23.0 | APR 1 | 5.0 |
| 4 | 4 | Styrene | 56.2 | n-butyl acrylate | 15.8 | CVRP 1 | 23.0 | APR 1 | 5.0 |
| 5 | 5 | Styrene | 56.2 | n-butyl acrylate | 15.8 | CVRP 1 | 23.0 | APR 1 | 5.0 |
| 6 | 6 | Styrene | 56.2 | n-butyl acrylate | 15.8 | CVRP 1 | 23.0 | APR 1 | 5.0 |
| 7 | 7 | Styrene | 56.2 | n-butyl acrylate | 15.8 | CVRP 1 | 23.0 | APR 1 | 5.0 |
| 8 | 8 | Styrene | 56.2 | n-butyl acrylate | 15.8 | CVRP 1 | 23.0 | APR 1 | 5.0 |
| 9 | 9 | Styrene | 56.2 | n-butyl acrylate | 15.8 | CVRP 1 | 23.0 | APR 1 | 5.0 |
| 10 | 10 | Styrene | 56.2 | n-butyl acrylate | 15.8 | CVRP 1 | 23.0 | APR 1 | 5.0 |
| 11 | 11 | Styrene | 56.2 | n-butyl acrylate | 15.8 | CVRP 1 | 23.0 | APR 1 | 5.0 |
| 12 | 12 | Styrene | 56.2 | n-butyl acrylate | 15.8 | CVRP 1 | 23.0 | APR 1 | 5.0 |
| 13 | 13 | Styrene | 56.2 | n-butyl acrylate | 15.8 | CVRP 1 | 23.0 | APR 1 | 5.0 |
| 14 | 14 | Styrene | 56.2 | n-butyl acrylate | 15.8 | CVRP 1 | 23.0 | APR 1 | 5.0 |
| 15 | 15 | Styrene | 56.2 | n-butyl acrylate | 15.8 | CVRP 1 | 23.0 | APR 1 | 5.0 |
| 16 | 16 | Styrene | 56.2 | n-butyl acrylate | 15.8 | CVRP 1 | 23.0 | APR 1 | 5.0 |
| 17 | 17 | Styrene | 56.2 | n-butyl acrylate | 15.8 | CVRP 1 | 23.0 | APR 1 | 5.0 |
| 18 | 18 | Styrene | 56.2 | n-butyl acrylate | 15.8 | CVRP 1 | 23.0 | APR 1 | 5.0 |
| 19 | 19 | Styrene | 56.2 | n-butyl acrylate | 15.8 | CVRP 1 | 23.0 | APR 1 | 5.0 |
| 20 | 20 | Styrene | 56.2 | n-butyl acrylate | 15.8 | CVRP 1 | 23.0 | APR 1 | 5.0 |
| 21 | 21 | Styrene | 56.2 | n-butyl acrylate | 15.8 | CVRP 1 | 23.0 | APR 1 | 5.0 |
| 22 | 22 | Styrene | 56.2 | n-butyl acrylate | 15.8 | CVRP 1 | 23.0 | APR 1 | 5.0 |
| 23 | 23 | Styrene | 56.2 | n-butyl acrylate | 15.8 | CVRP 1 | 23.0 | APR 1 | 5.0 |
| 24 | 24 | Styrene | 56.2 | n-butyl acrylate | 15.8 | CVRP 1 | 23.0 | APR 1 | 5.0 |
| 25 | 25 | Styrene | 56.2 | n-butyl acrylate | 15.8 | CVRP 1 | 23.0 | APR 1 | 5.0 |
| 26 | 26 | Styrene | 56.2 | n-butyl acrylate | 15.8 | CVRP 1 | 23.0 | APR 1 | 5.0 |
| 27 | 27 | Styrene | 56.2 | n-butyl acrylate | 15.8 | CVRP 1 | 23.0 | APR 1 | 5.0 |
| 28 | 28 | Styrene | 56.2 | n-butyl acrylate | 15.8 | CVRP 1 | 23.0 | APR 1 | 5.0 |
| 29 | 29 | Styrene | 56.2 | n-butyl acrylate | 15.8 | CVRP 1 | 23.0 | APR 1 | 5.0 |
| 30 | 30 | Styrene | 56.2 | n-butyl acrylate | 15.8 | CVRP 1 | 23.0 | APR 1 | 5.0 |
| 31 | 31 | Styrene | 56.2 | n-butyl acrylate | 15.8 | CVRP 1 | 23.0 | APR 1 | 5.0 |
| 32 | 32 | Styrene | 67.9 | n-butyl acrylate | 19.1 | CVRP 1 | 8.0 | APR 1 | 5.0 |
| 33 | 33 | Styrene | 64.0 | n-butyl acrylate | 18.0 | CVRP 1 | 13.0 | APR 1 | 5.0 |
| 34 | 34 | Styrene | 49.1 | n-butyl acrylate | 13.9 | CVRP 1 | 32.0 | APR 1 | 5.0 |
| 35 | 35 | Styrene | 39.0 | n-butyl acrylate | 11.0 | CVRP 1 | 45.0 | APR 1 | 5.0 |

TABLE 3-2

| | | Polymerizable | | Polymerizable | | | | | |
|---|---|---|---|---|---|---|---|---|---|
| | | monomer 1 | | monomer 2 | | CVRP | | APR | |
| E. | T. | | AoA | | AoA | | AoA | | AoA |
| No. | No. | Type | (part) | Type | (part) | Type | (part) | Type | (part) |
| 36 | 36 | Styrene | 35.1 | n-butyl acrylate | 9.9 | CVRP 1 | 50.0 | APR 1 | 5.0 |
| 37 | 37 | Styrene | 56.2 | n-butyl acrylate | 15.8 | CVRP 1 | 23.0 | APR 1 | 5.0 |
| 38 | 38 | Styrene | 56.2 | n-butyl acrylate | 15.8 | CVRP 1 | 23.0 | APR 1 | 5.0 |
| 39 | 39 | Styrene | 56.2 | n-butyl acrylate | 15.8 | CVRP 1 | 23.0 | APR 1 | 5.0 |
| 40 | 40 | Styrene | 56.2 | n-butyl acrylate | 15.8 | CVRP 1 | 23.0 | APR 1 | 5.0 |
| 41 | 41 | Styrene | 56.2 | n-butyl acrylate | 15.8 | CVRP 1 | 23.0 | APR 1 | 5.0 |
| 42 | 42 | Styrene | 56.2 | n-butyl acrylate | 15.8 | CVRP 1 | 23.0 | APR 1 | 5.0 |
| 43 | 43 | Styrene | 56.2 | n-butyl acrylate | 15.8 | CVRP 1 | 23.0 | APR 1 | 5.0 |
| 44 | 44 | Styrene | 56.2 | n-butyl acrylate | 15.8 | CVRP 1 | 23.0 | APR 1 | 5.0 |
| 45 | 45 | Styrene | 56.2 | n-butyl acrylate | 15.8 | CVRP 1 | 23.0 | APR 1 | 5.0 |
| 46 | 46 | Styrene | 56.2 | n-butyl acrylate | 15.8 | CVRP 1 | 23.0 | APR 1 | 5.0 |
| 47 | 47 | Styrene | 56.2 | n-lauryl acrylate | 15.8 | CVRP 1 | 23.0 | APR 1 | 5.0 |
| 48 | 48 | Styrene | 51.8 | Ethyl acrylate | 20.2 | CVRP 1 | 23.0 | APR 1 | 5.0 |
| 49 | 49 | Styrene | 49.0 | n-stearyl acrylate | 23.0 | CVRP 1 | 23.0 | APR 1 | 5.0 |
| 50 | 50 | Styrene | 56.2 | n-butyl acrylate | 15.8 | CVRP 1 | 23.0 | APR 2 | 5.0 |
| 51 | 51 | Styrene | 56.2 | n-butyl acrylate | 15.8 | CVRP 1 | 23.0 | APR 3 | 5.0 |
| 52 | 52 | Styrene | 56.2 | n-butyl acrylate | 15.8 | CVRP 1 | 23.0 | APR 4 | 5.0 |
| 53 | 53 | Styrene | 59.4 | n-butyl acrylate | 16.8 | CVRP 1 | 23.0 | APR 1 | 0.8 |
| 54 | 54 | Styrene | 58.5 | n-butyl acrylate | 16.5 | CVRP 1 | 23.0 | APR 1 | 2.0 |
| 55 | 55 | Styrene | 49.1 | n-butyl acrylate | 13.9 | CVRP 1 | 23.0 | APR 1 | 14.0 |
| 56 | 56 | Styrene | 47.6 | n-butyl acrylate | 13.4 | CVRP 1 | 23.0 | APR 1 | 16.0 |
| 57 | 57 | Styrene | 56.2 | n-butyl acrylate | 15.8 | CVRP 1 | 23.0 | APR 1 | 5.0 |
| 58 | 58 | Styrene | 56.2 | n-butyl acrylate | 15.8 | CVRP 1 | 23.0 | APR 1 | 5.0 |
| 59 | 59 | Styrene | 56.2 | n-butyl acrylate | 15.8 | CVRP 1 | 23.0 | APR 1 | 5.0 |
| 60 | 60 | Styrene | 56.2 | n-butyl acrylate | 15.8 | CVRP 1 | 23.0 | APR 1 | 5.0 |
| 61 | 61 | Styrene | 56.2 | n-butyl acrylate | 15.8 | CVRP 1 | 23.0 | APR 4 | 5.0 |
| C.2 | C.2 | Styrene | 56.2 | n-butyl acrylate | 15.8 | CVRP 1 | 23.0 | APR 1 | 5.0 |
| C.3 | C.3 | Styrene | 56.2 | n-butyl acrylate | 15.8 | CVRP 1 | 23.0 | APR 1 | 5.0 |
| C.4 | C.4 | Styrene | 56.2 | n-butyl acrylate | 15.8 | CVRP 1 | 23.0 | APR 1 | 5.0 |
| C.5 | C.5 | Styrene | 56.2 | n-butyl acrylate | 15.8 | CVRP 1 | 23.0 | APR 1 | 5.0 |
| C.6 | C.6 | Styrene | 56.2 | n-butyl acrylate | 15.8 | CVRP 1 | 23.0 | APR 1 | 5.0 |
| C.7 | C.7 | Styrene | 56.2 | n-butyl acrylate | 15.8 | CVRP 1 | 23.0 | APR 1 | 5.0 |
| C.8 | C.8 | Styrene | 56.2 | n-butyl acrylate | 15.8 | CVRP 1 | 23.0 | APR 1 | 5.0 |
| C.9 | C.9 | Styrene | 56.2 | n-butyl acrylate | 15.8 | CVRP 1 | 23.0 | APR 1 | 5.0 |
| C.10 | C.10 | Styrene | 56.2 | n-butyl acrylate | 15.8 | CVRP 1 | 23.0 | APR 1 | 5.0 |

In the Tables 3-1 and 3-2, “E.” represents “example”, “C.” represents “comparison”, “T.” represents “toner”, “AoA” represents “amount of addition”, “CVRP” represents “crystalline vinyl resin precursor”, and “APR” represents “amorphous polyester resin”

TABLE 3-3

| | | Ester wax W1 | | Ester wax W2 | | | |
|---|---|---|---|---|---|---|---|
| E. | T | | AoA | | AoA | PRT | TLS |
| No. | No. | Type | (part) | Type | (part) | (° C.) | (° C./min) |
| E.1 | 1 | Ethylene glycol dibehenate | 9.0 | Dipentaerythritol hexabehenate | 5.0 | 76.0 | 100 |
| E.2 | 2 | Ethylene glycol dibehenate | 9.0 | Dipentaerythritol hexabehenate | 5.0 | 76.0 | 100 |
| E.3 | 3 | Ethylene glycol dibehenate | 9.0 | Dipentaerythritol hexabehenate | 5.0 | 76.0 | 100 |
| E.4 | 4 | Ethylene glycol diarachidate | 9.0 | Dipentaerythritol hexabehenate | 5.0 | 76.0 | 100 |
| E.5 | 5 | Ethylene glycol distearate | 9.0 | Dipentaerythritol hexabehenate | 5.0 | 76.0 | 100 |
| E.6 | 6 | Ethylene glycol dimyristate | 9.0 | Dipentaerythritol hexabehenate | 5.0 | 76.0 | 100 |
| E.7 | 7 | Ethylene glycol dihexacosanoate | 9.0 | Dipentaerythritol hexabehenate | 5.0 | 76.0 | 100 |
| E.8 | 8 | Ethylene glycol dimyricate | 9.0 | Dipentaerythritol hexabehenate | 5.0 | 76.0 | 100 |
| E.9 | 9 | Hexanediol distearate | 9.0 | Dipentaerythritol hexabehenate | 5.0 | 76.0 | 100 |
| E.10 | 10 | Hexanediol dibehenate | 9.0 | Dipentaerythritol hexabehenate | 5.0 | 76.0 | 100 |
| E.11 | 11 | Decanediol distearate | 9.0 | Dipentaerythritol hexabehenate | 5.0 | 76.0 | 100 |
| E.12 | 12 | Decanediol dibehenate | 9.0 | Dipentaerythritol hexabehenate | 5.0 | 76.0 | 100 |
| E.13 | 13 | Hexadecanediol dibehenate | 9.0 | Dipentaerythritol hexabehenate | 5.0 | 76.0 | 100 |
| E.14 | 14 | Dibehenyl succinate | 9.0 | Dipentaerythritol hexabehenate | 5.0 | 76.0 | 100 |
| E.15 | 15 | Diarachidyl succinate | 9.0 | Dipentaerythritol hexabehenate | 5.0 | 76.0 | 100 |
| E.16 | 16 | Distearyl succinate | 9.0 | Dipentaerythritol hexabehenate | 5.0 | 76.0 | 100 |
| E.17 | 17 | Dimyristyl succinate | 9.0 | Dipentaerythritol hexabehenate | 5.0 | 76.0 | 100 |
| E.18 | 18 | Dihexacosyl succinate | 9.0 | Dipentaerythritol hexabehenate | 5.0 | 76.0 | 100 |
| E.19 | 19 | Dimyricyl succinate | 9.0 | Dipentaerythritol hexabehenate | 5.0 | 76.0 | 100 |
| E.20 | 20 | Distearyl succinate | 9.0 | Dipentaerythritol hexabehenate | 5.0 | 76.0 | 100 |
| E.21 | 21 | Dibehenyl succinate | 9.0 | Dipentaerythritol hexabehenate | 5.0 | 76.0 | 100 |
| E.22 | 22 | Distearyl sebacate | 9.0 | Dipentaerythritol hexabehenate | 5.0 | 76.0 | 100 |
| E.23 | 23 | Dibehenyl sebacate | 9.0 | Dipentaerythritol hexabehenate | 5.0 | 76.0 | 100 |
| E.24 | 24 | Dibehenyl hexadecanedioate | 9.0 | Dipentaerythritol hexabehenate | 5.0 | 76.0 | 100 |
| E.25 | 25 | Beheny behenate | 9.0 | Dipentaerythritol hexabehenate | 5.0 | 76.0 | 100 |
| E.26 | 26 | Behenyl stearate | 9.0 | Dipentaerythritol hexabehenate | 5.0 | 76.0 | 100 |
| E.27 | 27 | Behenyl behenate | 9.0 | Dipentaerythritol hexabehenate | 5.0 | 76.0 | 100 |
| E.28 | 28 | Stearyl stearate | 9.0 | Dipentaerythritol hexabehenate | 5.0 | 76.0 | 100 |
| E.29 | 29 | Myristyl Myristate | 9.0 | Dipentaerythritol hexabehenate | 5.0 | 76.0 | 100 |
| E.30 | 30 | Hexacosyl behenate | 9.0 | Dipentaerythritol hexabehenate | 5.0 | 76.0 | 100 |
| E.31 | 31 | Myricyl behenate | 9.0 | Dipentaerythritol hexabehenate | 5.0 | 76.0 | 100 |
| E.32 | 32 | Ethylene glycol dibehenate | 2.5 | Dipentaerythritol hexabehenate | 5.0 | 76.0 | 100 |
| E.33 | 33 | Ethylene glycol dibehenate | 4.0 | Dipentaerythritol hexabehenate | 5.0 | 76.0 | 100 |
| E.34 | 34 | Ethylene glycol dibehenate | 12.0 | Dipentaerythritol hexabehenate | 5.0 | 76.0 | 100 |
| E.35 | 35 | Ethylene glycol dibehenate | 15.0 | Dipentaerythritol hexabehenate | 5.0 | 76.0 | 100 |

TABLE 3-4

| | | Ester wax W1 | | Ester wax W2 | | | |
|---|---|---|---|---|---|---|---|
| E. | T. | | AoA | | AoA | PRT | TLS |
| No. | No. | Type | (part) | Type | (part | (° C.) | (° C./min) |
| E.36 | 36 | Ethylene glycol dibehenate | 15.0 | Dipentaerythritol hexabehenate | 5.0 | 76.0 | 100 |
| E.37 | 37 | Ethylene glycol dibehenate | 5.0 | Dipentaerythritol hexabehenate | 5.0 | 76.0 | 100 |
| E.38 | 38 | Ethylene glycol dibehenate | 7.0 | Dipentaerythritol hexabehenate | 5.0 | 76.0 | 100 |
| E.39 | 39 | Ethylene glycol dibehenate | 18.0 | Dipentaerythritol hexabehenate | 5.0 | 76.0 | 100 |
| E.40 | 40 | Ethylene glycol dibehenate | 11.0 | Dipentaerythritol hexabehenate | 5.0 | 70.0 | 100 |
| E.41 | 41 | Ethylene glycol dibehenate | 14.0 | Dipentaerythritol hexabehenate | 5.0 | 70.0 | 100 |
| E.42 | 42 | Ethylene glycol dibehenate | 9.0 | Dipentaerythritol hexabehenate | 5.0 | 76.0 | 200 |
| E.43 | 43 | Ethylene glycol dibehenate | 9.0 | Dipentaerythritol hexabehenate | 5.0 | 76.0 | 180 |
| E.44 | 44 | Ethylene glycol dibehenate | 9.0 | Dipentaerythritol hexabehenate | 5.0 | 76.0 | 80 |
| E.45 | 45 | Ethylene glycol dibehenate | 9.0 | Dipentaerythritol hexabehenate | 5.0 | 76.0 | 30 |
| E.46 | 46 | Ethylene glycol dibehenate | 9.0 | Dipentaerythritol hexabehenate | 5.0 | 76.0 | 10 |
| E.47 | 47 | Ethylene glycol dibehenate | 9.0 | Dipentaerythritol hexabehenate | 5.0 | 76.0 | 100 |
| E.48 | 48 | Ethylene glycol dibehenate | 9.0 | Dipentaerythritol hexabehenate | 5.0 | 76.0 | 100 |
| E.49 | 49 | Ethylene glycol dibehenate | 9.0 | Dipentaerythritol hexabehenate | 5.0 | 76.0 | 100 |
| E.50 | 50 | Ethylene glycol dibehenate | 9.0 | Dipentaerythritol hexabehenate | 5.0 | 76.0 | 100 |
| E.51 | 51 | Ethylene glycol dibehenate | 9.0 | Dipentaerythritol hexabehenate | 5.0 | 76.0 | 100 |
| E.52 | 62 | Ethylene glycol dibehenate | 9.0 | Dipentaerythritol hexabehenate | 5.0 | 76.0 | 100 |
| E.53 | 53 | Ethylene glycol dibehenate | 9.0 | Dipentaerythritol hexabehenate | 5.0 | 76.0 | 100 |
| E.54 | 54 | Ethylene glycol dibehenate | 9.0 | Dipentaerythritol hexabehenate | 5.0 | 76.0 | 100 |
| E.55 | 55 | Ethylene glycol dibehenate | 9.0 | Dipentaerythritol hexabehenate | 5.0 | 76.0 | 100 |
| E.56 | 66 | Ethylene glycol dibehenate | 9.0 | Dipentaerythritol hexabehenate | 5.0 | 76.0 | 100 |
| E.57 | 57 | Ethylene glycol dibehenate | 9.0 | Pentaerythritol tetrastearate | 5.0 | 76.0 | 100 |
| E.58 | 58 | Ethylene glycol dibehenate | 9.0 | Dipentaerythritol hexastearate | 5.0 | 76.0 | 100 |
| E.59 | 59 | Ethylene glycol dibehenate | 9.0 | Dipentaerythritol hexapalmitate | 5.0 | 76.0 | 100 |
| E.60 | 60 | Ethylene glycol dibehenate | 9.0 | — | — | 76.0 | 100 |
| E.61 | 61 | Ethylene glycol dibehenate | 9.0 | — | — | 76.0 | 100 |
| C.E.2 | C.2 | Glycerin Tribehenale | 9.0 | — | — | 76.0 | 100 |
| C.E.3 | C.3 | — | — | Dipentaerythritol hexabehenate | 5.0 | 76.0 | 100 |
| C.E.4 | C.4 | Ethylene glycol ditridecanoate | 9.0 | Dipentaerythritol hexabehenate | 5.0 | 76.0 | 100 |
| C.E.5 | C.5 | Ethylene glycol difridecanoate | 9.0 | — | — | 76.0 | 100 |
| C.E.6 | C.6 | Octadecanediol dibehenate | 9.0 | — | — | 76.0 | 100 |
| C.E.7 | C.7 | Ditridecyl succinate | 9.0 | — | — | 76.0 | 100 |
| C.E.8 | C.8 | Dibehenyl octadecanedioate | 9.0 | — | — | 76.0 | 100 |
| C.E.9 | C.9 | Tridecyl tridecanoale | 9.0 | — | — | 76.0 | 100 |
| C.E.10 | C.10 | Ethylene glycol dibehenate | 9.0 | Dipentaerythritol hexabehenate | 5.0 | 76.0 | 0.6 |

In the Tables 3-3 and 3-4, “E.” represents “example”, “C.E.” represents “comparative example”, “C.” represents “comparison”, “T.” represents “toner”, “AoA” represents “amount of addition”, “PRT” represents “polymerization reaction temperature”, and “TLS” represents “Temperature lowering speed in cooling process.

TABLE 4-1

| E. | T. | D | | W1 | W1 | W1 | W1 | W1 | W1 | d | | W2 |
|---|---|---|---|---|---|---|---|---|---|---|---|---|
| No. | No. | (μm) | R2 | C_{R3} | C_{R4} | C_{R5} | C_{R6} | C_{R7} | C_{R8} | (nm) | nd | C_{R12} |
| 1 | 1 | 6.2 | 22 | — | — | 21 | 2 | — | — | 45 | 274.5 | 21 |
| 2 | 2 | 6.3 | 22 | — | — | 21 | 2 | — | — | 44 | 234.8 | 21 |
| 3 | 3 | 6.4 | 22 | — | — | 21 | 2 | — | — | 46 | 256.3 | 21 |
| 4 | 4 | 6.3 | 22 | — | — | 19 | 2 | — | — | 45 | 241.3 | 21 |
| 5 | 5 | 6.5 | 22 | — | — | 17 | 2 | — | — | 48 | 214.4 | 21 |
| 6 | 6 | 6.4 | 22 | — | — | 13 | 2 | — | — | 65 | 180.5 | 21 |
| 7 | 7 | 6.3 | 22 | — | — | 25 | 2 | — | — | 40 | 285.7 | 21 |
| 8 | 8 | 6.2 | 22 | — | — | 29 | 2 | — | — | 25 | 331.2 | 21 |
| 9 | 9 | 6.5 | 22 | — | — | 17 | 6 | — | — | 45 | 242.1 | 21 |
| 10 | 10 | 6.4 | 22 | — | — | 21 | 6 | — | — | 40 | 244.0 | 21 |
| 11 | 11 | 6.2 | 22 | — | — | 17 | 10 | — | — | 40 | 198.7 | 21 |
| 12 | 12 | 6.6 | 22 | — | — | 21 | 10 | — | — | 38 | 283.9 | 21 |
| 13 | 13 | 6.1 | 22 | — | — | 21 | 16 | — | — | 35 | 262.2 | 21 |
| 14 | 14 | 6.5 | 22 | — | — | — | — | 22 | 2 | 46 | 218.2 | 21 |
| 15 | 15 | 6.4 | 22 | — | — | — | — | 20 | 2 | 44 | 272.5 | 21 |
| 16 | 16 | 6.2 | 22 | — | — | — | — | 18 | 2 | 47 | 206.2 | 21 |
| 17 | 17 | 6.6 | 22 | — | — | — | — | 14 | 2 | 65 | 181.6 | 21 |
| 18 | 18 | 6.1 | 22 | — | — | — | — | 26 | 2 | 41 | 244.4 | 21 |
| 19 | 19 | 6.5 | 22 | — | — | — | — | 30 | 2 | 27 | 331.1 | 21 |
| 20 | 20 | 6.5 | 22 | — | — | — | — | 18 | 6 | 46 | 229.0 | 21 |
| 21 | 21 | 6.5 | 22 | — | — | — | — | 22 | 6 | 39 | 273.3 | 21 |
| 22 | 22 | 6.5 | 22 | — | — | — | — | 18 | 8 | 41 | 228.2 | 21 |
| 23 | 23 | 6.1 | 22 | — | — | — | — | 22 | 8 | 37 | 256.5 | 21 |
| 24 | 24 | 6.4 | 22 | — | — | — | — | 22 | 14 | 35 | 206.2 | 21 |
| 25 | 25 | 6.4 | 22 | 21 | 22 | — | — | — | — | 46 | 277.6 | 21 |
| 26 | 26 | 6.2 | 22 | 17 | 22 | — | — | — | — | 44 | 211.3 | 21 |
| 27 | 27 | 6.6 | 22 | 21 | 18 | — | — | — | — | 44 | 268.1 | 21 |
| 28 | 28 | 6.1 | 22 | 17 | 18 | — | — | — | — | 43 | 267.6 | 21 |
| 29 | 29 | 6.2 | 22 | 13 | 14 | — | — | — | — | 62 | 190.5 | 21 |
| 30 | 30 | 6.4 | 22 | 21 | 26 | — | — | — | — | 39 | 280.5 | 21 |
| 31 | 31 | 6.4 | 22 | 21 | 30 | — | — | — | — | 28 | 340.3 | 21 |
| 32 | 32 | 6.4 | 22 | — | — | 21 | 2 | — | — | 42 | 50.5 | 21 |
| 33 | 33 | 6.4 | 22 | — | — | 21 | 2 | — | — | 43 | 103.1 | 21 |
| 34 | 34 | 6.5 | 22 | — | — | 21 | 2 | — | — | 44 | 284.5 | 21 |
| 35 | 35 | 6.7 | 22 | — | — | 21 | 2 | — | — | 45 | 321.1 | 21 |

TABLE 4-2

| E. | T. | D | | W1 | W1 | W1 | W1 | W1 | W1 | d | | W2 |
|---|---|---|---|---|---|---|---|---|---|---|---|---|
| No. | No | (μm) | R2 | C_{R3} | C_{R4} | C_{R5} | C_{R6} | C_{R7} | C_{R8} | (nm) | nd | CR₁₂ |
| 36 | 36 | 6.6 | 22 | — | — | 21 | 2 | — | — | 44 | 333.6 | 21 |
| 37 | 37 | 6.4 | 22 | — | — | 21 | 2 | — | — | 45 | 253.6 | 21 |
| 38 | 38 | 6.4 | 22 | — | — | 21 | 2 | — | — | 43 | 248.3 | 21 |
| 39 | 39 | 6.4 | 22 | — | — | 21 | 2 | — | — | 44 | 280.5 | 21 |
| 40 | 40 | 6.4 | 22 | — | — | 21 | 2 | — | — | 46 | 209.2 | 21 |
| 41 | 41 | 6.4 | 22 | — | — | 21 | 2 | — | — | 46 | 238.4 | 21 |
| 42 | 42 | 6.2 | 22 | — | — | 21 | 2 | — | — | 15 | 400.3 | 21 |
| 43 | 43 | 6.6 | 22 | — | — | 21 | 2 | — | — | 23 | 345.5 | 21 |
| 44 | 44 | 6.3 | 22 | — | — | 21 | 2 | — | — | 85 | 202.3 | 21 |
| 45 | 45 | 6.5 | 22 | — | — | 21 | 2 | — | — | 180 | 199.6 | 21 |
| 46 | 46 | 6 | 22 | — | — | 21 | 2 | — | — | 220 | 53.5 | 21 |
| 47 | 47 | 6.2 | 22 | — | — | 21 | 2 | — | — | 44 | 273.6 | 21 |
| 48 | 48 | 6.5 | 22 | — | — | 21 | 2 | — | — | 31 | 200.1 | 21 |
| 49 | 49 | 6.4 | 22 | — | — | 21 | 2 | — | — | 43 | 203.5 | 21 |
| 50 | 50 | 6.4 | 22 | — | — | 21 | 2 | — | — | 43 | 257.9 | 21 |
| 51 | 51 | 6.4 | 22 | — | — | 21 | 2 | — | — | 43 | 234.3 | 21 |
| 52 | 52 | 6.4 | 22 | — | — | 21 | 2 | — | — | 43 | 270.3 | 21 |
| 53 | 53 | 6.5 | 22 | — | — | 21 | 2 | — | — | 41 | 281.9 | 21 |
| 54 | 54 | 6.3 | 22 | — | — | 21 | 2 | — | — | 44 | 245.2 | 21 |
| 55 | 55 | 6.4 | 22 | — | — | 21 | 2 | — | — | 43 | 221.4 | 21 |
| 56 | 56 | 6.6 | 22 | — | — | 21 | 2 | — | — | 42 | 237.3 | 21 |
| 57 | 57 | 6.6 | 22 | — | — | 21 | 2 | — | — | 42 | 258.0 | 17 |
| 58 | 58 | 6.5 | 22 | — | — | 21 | 2 | — | — | 43 | 271.8 | 17 |
| 59 | 59 | 6.6 | 22 | — | — | 21 | 2 | — | — | 42 | 223.6 | 15 |
| 60 | 60 | 6.6 | 22 | — | — | 21 | 2 | — | — | 38 | 210.5 | — |
| 61 | 61 | 6.5 | 22 | — | — | 21 | 2 | — | — | 39 | 288.0 | — |
| 62 | 62 | 6.2 | 22 | — | — | 21 | 2 | — | — | 45 | 240.4 | 21 |
| C.E.1 | C.1 | 6.2 | 22 | — | — | — | — | — | — | N | 0 | — |
| C.E.2 | C.2 | 6.2 | 22 | — | — | — | — | — | — | N | 0 | — |
| C.E.3 | C.3 | 6.3 | 22 | — | — | — | — | — | — | N | 0 | 21 |
| C.E.4 | C.4 | 6.5 | 22 | — | — | 12 | 2 | — | — | 55 | 266.4 | 21 |
| C.E.5 | C.5 | 6.5 | 22 | — | — | 12 | 2 | — | — | 55 | 219.6 | — |
| C.E.6 | C.6 | 6.4 | 22 | — | — | 21 | 18 | — | — | 35 | 45.5 | — |
| C.E.7 | C.7 | 6.3 | 22 | — | — | — | — | 13 | 2 | 58 | 218.0 | — |
| C.E.8 | C.8 | 6.3 | 22 | — | — | — | — | 22 | 16 | 33 | 56.1 | — |
| C.E.9 | C.9 | 6.5 | 22 | 12 | 13 | — | — | — | — | 59 | 255.4 | — |
| C.E.10 | C.10 | 6.3 | 22 | — | — | 21 | 2 | — | — | N | 0 | 21 |

In the Tables 4-1 and 4-2, “E.” represents “example”, “C.E.” represents “comparative example”, “C.” represents “comparison”, “T.” represents “toner”, “C_{R3}” represents “number of carbon atoms in R3, “C_{R4}” represents “number of carbon atoms in R4, “C_{R5}” represents “number of carbon atoms in R5, “C_{R6}” represents “number of carbon atoms in R6, “C_{R7}” represents “number of carbon atoms in R7, “C_{R8}” represents “number of carbon atoms in R8.”, and “C_{R12}” represents “number of carbon atoms in R12.”

D is a number average particle diameter of the toner.

R2 is the number of carbon atoms in R² in Formula (1).

In Examples 1 to 61 and Comparative Examples 4 to 9, domains containing the ester wax W1 as a main component were present in the amorphous phases.

d is a number average value of the long diameters of the domains of the ester wax W1 that are present in the amorphous phase. N in the column d indicates that there are no domains in the amorphous phase.

nd indicates the number of domains that are present in the amorphous phases and contain the ester wax W1 as a main component per toner particle.

TABLE 4-3

| | | \|C_{R3}-C_{R2}\| | | | | | | | | | | |
|---|---|---|---|---|---|---|---|---|---|---|---|---|
| E. | T. | or | \|C_{R5}- | \|C_{R7}- | \|C_{R12}- | \|CR₁₂- | | | | | | |
| No. | No. | \|C_{R4}-C_{R2}\| | C_{R2}\| | C_{R2}\| | C_{R5}\| | C_{R2}\| | M1 | M2 | M3 | S1 | d/D | Mw |
| 1 | 1 | — | 1 | — | 0 | 1 | 53.1 | 16.9 | 5.0 | 59.0 | 7.3.E−03 | 150200 |
| 2 | 2 | — | 1 | — | 0 | 1 | 54.5 | 16.5 | 5.0 | 57.0 | 7.0.E−03 | 155900 |
| 3 | 3 | — | 1 | — | 0 | 1 | 56.2 | 16.0 | 5.0 | 55.0 | 7.2.E−03 | 152100 |
| 4 | 4 | — | 3 | — | 2 | 1 | 53.3 | 16.9 | 5.0 | 57.0 | 7.1.E−03 | 159700 |
| 5 | 5 | — | 5 | — | 4 | 1 | 54.0 | 16.7 | 5.0 | 58.0 | 7.4.E−03 | 159700 |
| 6 | 6 | — | 9 | — | 8 | 1 | 56.5 | 15.9 | 5.0 | 55.0 | 1.0.E−02 | 161600 |
| 7 | 7 | — | 3 | — | 4 | 1 | 51.5 | 17.5 | 5.0 | 61.0 | 6.3.E−03 | 163500 |
| 8 | 8 | — | 7 | — | 8 | 1 | 49.9 | 18.0 | 5.0 | 63.0 | 4.0.E−03 | 152100 |
| 9 | 9 | — | 5 | — | 4 | 1 | 51.6 | 17.4 | 5.0 | 59.9 | 6.9.E−03 | 152100 |
| 10 | 10 | — | 1 | — | 0 | 1 | 52.8 | 17.0 | 5.0 | 58.0 | 6.3.E−03 | 163500 |
| 11 | 11 | — | 5 | — | 4 | 1 | 51.9 | 17.3 | 5.0 | 59.5 | 6.5.E−03 | 154000 |
| 12 | 12 | — | 1 | — | 0 | 1 | 52.6 | 17.1 | 5.0 | 59.2 | 5.8.E−03 | 159700 |
| 13 | 13 | — | 1 | — | 0 | 1 | 53.1 | 16.9 | 5.0 | 61.0 | 5.7.E−03 | 161600 |
| 14 | 14 | — | — | 0 | — | 1 | 53.1 | 16.9 | 5.0 | 60.0 | 7.1.E−03 | 152100 |
| 15 | 15 | — | — | 2 | — | 1 | 53.1 | 16.9 | 5.0 | 55.5 | 6.9.E−03 | 152100 |
| 16 | 16 | — | — | 4 | — | 1 | 54.1 | 16.6 | 5.0 | 57.7 | 7.6.E−03 | 163500 |
| 17 | 17 | — | — | 8 | — | 1 | 56.6 | 15.9 | 5.0 | 57.0 | 9.8.E−03 | 154000 |
| 18 | 18 | — | — | 4 | — | 1 | 51.3 | 17.5 | 5.0 | 61.0 | 6.7.E−03 | 159700 |
| 19 | 19 | — | — | 8 | — | 1 | 50.0 | 18.0 | 5.0 | 63.0 | 4.2.E−03 | 150200 |
| 20 | 20 | — | — | 4 | — | 1 | 51.8 | 17.4 | 5.0 | 59.0 | 7.1.E−03 | 163500 |
| 21 | 21 | — | — | 0 | — | 1 | 52.7 | 17.1 | 5.0 | 60.0 | 6.0.E−03 | 163500 |
| 22 | 22 | — | — | 4 | — | 1 | 51.8 | 17.4 | 5.0 | 60.0 | 6.3.E−03 | 155900 |
| 23 | 23 | — | — | 0 | — | 1 | 52.7 | 17.1 | 5.0 | 59.4 | 6.1.E−03 | 159700 |
| 24 | 24 | — | — | 0 | — | 1 | 53.0 | 17.0 | 5.0 | 60.5 | 5.5.E−03 | 155900 |
| 25 | 25 | 0 | — | — | — | 1 | 53.1 | 16.9 | 5.0 | 59.5 | 7.2.E−03 | 154000 |
| 26 | 26 | 0 | — | — | — | 1 | 53.0 | 17.0 | 5.0 | 59.2 | 7.1.E−03 | 161600 |
| 27 | 27 | 1 | — | — | — | 1 | 53.3 | 16.9 | 5.0 | 59.0 | 6.7.E−03 | 159700 |
| 28 | 28 | 4 | — | — | — | 1 | 52.8 | 17.0 | 5.0 | 59.4 | 7.0.E−03 | 152100 |
| 29 | 29 | 8 | — | — | — | 1 | 56.1 | 16.0 | 5.0 | 57.2 | 1.0.E−02 | 159700 |
| 30 | 30 | 1 | — | — | — | 1 | 51.2 | 17.6 | 5.0 | 61.2 | 6.1.E−03 | 161600 |
| 31 | 31 | 1 | — | — | — | 1 | 48.9 | 18.4 | 5.0 | 63.0 | 4.4.E−03 | 159700 |
| 32 | 32 | — | 1 | — | 0 | 1 | 14.0 | 17.9 | 5.0 | 110.0 | 6.6.E−03 | 157800 |
| 33 | 33 | — | 1 | — | 0 | 1 | 22.1 | 18.1 | 5.0 | 90.5 | 6.7.E−03 | 157800 |
| 34 | 34 | — | 1 | — | 0 | 1 | 67.0 | 17.9 | 5.0 | 45.0 | 6.8.E−03 | 152100 |
| 35 | 35 | — | 1 | — | 0 | 1 | 80.0 | 18.8 | 5.0 | 23.0 | 6.7.E−03 | 159700 |

TABLE 4-4

| | | \|C_{R3}-C_{R2}\| | | | | | | | | | | |
|---|---|---|---|---|---|---|---|---|---|---|---|---|
| E. | T. | or | \|C_{R5}- | \|C_{R7}- | \|C_{R12}- | \|CR₁₂- | | | | | | |
| No. | No. | \|C_{R4}-C_{R2}\| | C_{R2}\| | C_{R2}\| | C_{R5}\| | C_{R2}\| | M1 | M2 | M3 | S1 | d/D | Mw |
| 36 | 36 | — | 1 | — | 0 | 1 | 85.0 | 17.6 | 5.0 | 16.0 | 6.7.E−03 | 154000 |
| 37 | 37 | — | 1 | — | 0 | 1 | 53.5 | 9.3 | 5.0 | 58.0 | 7.0.E−03 | 152100 |
| 38 | 38 | — | 1 | — | 0 | 1 | 51.0 | 13.7 | 5.0 | 59.0 | 6.7.E−03 | 152100 |
| 39 | 39 | — | 1 | — | 0 | 1 | 53.0 | 34.0 | 5.0 | 57.0 | 6.9.E−03 | 161600 |
| 40 | 40 | — | 1 | — | 0 | 1 | 25.0 | 44.0 | 5.0 | 82.0 | 7.2.E−03 | 104800 |
| 41 | 41 | — | 1 | — | 0 | 1 | 25.0 | 56.0 | 5.0 | 80.0 | 7.2.E−03 | 103000 |
| 42 | 42 | — | 1 | — | 0 | 1 | 53.4 | 16.9 | 5.0 | 58.0 | 2.4.E−03 | 163500 |
| 43 | 43 | — | 1 | — | 0 | 1 | 53.5 | 16.8 | 5.0 | 59.0 | 3.5.E−03 | 157800 |
| 44 | 44 | — | 1 | — | 0 | 1 | 53.5 | 16.8 | 5.0 | 57.5 | 1.3.E−02 | 163500 |
| 45 | 45 | — | 1 | — | 0 | 1 | 53.5 | 16.8 | 5.0 | 58.8 | 2.8.E−02 | 150200 |
| 46 | 46 | — | 1 | — | 0 | 1 | 53.3 | 16.9 | 5.0 | 59.0 | 3.7.E−02 | 157800 |
| 47 | 47 | — | 1 | — | 0 | 1 | 53.0 | 17.0 | 5.0 | 59.0 | 7.1.E−03 | 159700 |
| 48 | 48 | — | 1 | — | 0 | 1 | 53.5 | 16.8 | 5.0 | 59.5 | 4.8.E−03 | 150200 |
| 49 | 49 | — | 1 | — | 0 | 1 | 52.5 | 17.1 | 5.0 | 58.0 | 6.7.E−03 | 157800 |
| 50 | 50 | — | 1 | — | 0 | 1 | 53.1 | 16.9 | 5.0 | 58.0 | 6.7.E−03 | 157800 |
| 51 | 51 | — | 1 | — | 0 | 1 | 53.1 | 16.9 | 5.0 | 58.0 | 6.7.E−03 | 155900 |
| 52 | 52 | — | 1 | — | 0 | 1 | 53.1 | 16.9 | 5.0 | 58.0 | 6.7.E−03 | 161600 |
| 53 | 53 | — | 1 | — | 0 | 1 | 53.0 | 17.0 | 0.8 | 59.0 | 6.3.E−03 | 150200 |
| 54 | 54 | — | 1 | — | 0 | 1 | 53.3 | 16.9 | 2.0 | 58.0 | 7.0.E−03 | 161600 |
| 55 | 55 | — | 1 | — | 0 | 1 | 52.4 | 17.2 | 14.0 | 57.0 | 6.7.E−03 | 157800 |
| 56 | 56 | — | 1 | — | 0 | 1 | 52.5 | 17.1 | 16.0 | 56.0 | 6.4.E−03 | 161600 |
| 57 | 57 | — | 1 | — | 4 | 1 | 52.5 | 17.1 | 5.0 | 59.0 | 6.4.E−03 | 150200 |
| 58 | 58 | — | 1 | — | 4 | 1 | 52.3 | 17.2 | 5.0 | 58.0 | 6.6.E−03 | 159700 |
| 59 | 59 | — | 1 | — | 6 | 1 | 52.5 | 17.1 | 5.0 | 59.0 | 6.4.E−03 | 155900 |
| 60 | 60 | — | 1 | — | — | — | 53.0 | 17.0 | 5.0 | 58.0 | 5.8.E−03 | 152100 |
| 61 | 61 | — | 1 | — | — | — | 52.4 | 17.2 | 5.0 | 57.0 | 6.0.E−03 | 161600 |
| 62 | 62 | — | 1 | — | — | — | 53.1 | 16.9 | 5.0 | 59.0 | 7.3.E−03 | 30200 |
| C.E.3 | C.1 | — | — | — | — | — | 40.0 | — | 4.6 | 65.0 | — | 99400 |
| C.E.2 | C.2 | — | — | — | — | — | 53.1 | 16.9 | 5.0 | 58.0 | — | 152100 |
| C.E.3 | C.3 | — | — | — | — | 1 | 53.1 | 0.0 | 5.0 | 57.0 | — | 159700 |
| C.E.4 | C.4 | — | 10 | — | 9 | 1 | 53.1 | 16.9 | 5.0 | 59.0 | 8.5.E−03 | 152100 |
| C.E.5 | C.5 | — | 10 | — | — | — | 53.1 | 16.9 | 5.0 | 59.0 | 8.5.E−03 | 152100 |
| C.E.6 | C.6 | — | 1 | — | — | — | 53.5 | 16.8 | 5.0 | 57.0 | 5.5.E−03 | 159700 |
| C.E.7 | C.7 | — | — | 9 | — | — | 52.9 | 17.0 | 5.0 | 58.0 | 9.2.E−03 | 154000 |
| C.E.8 | C.8 | — | — | 0 | — | — | 53.3 | 16.9 | 5.0 | 57.0 | 5.2.E−03 | 163500 |
| C.E.9 | C.9 | — | — | — | — | — | 53.5 | 16.8 | 5.0 | 59.0 | 9.1.E−03 | 150200 |
| C.E.10 | C.10 | — | 1 | — | 1 | 1 | 53.1 | 16.9 | 5.0 | 57.0 | — | 150200 |

In the Tables 4-3 and 4-4, “E.” represents “example”, “C.E.” represents “comparative example”, “C.” represents “comparison”, and “T.” represents “toner”

M1 is the content rate (00 by mass) of crystalline vinyl resin in the binder resin.

M2 denotes a content (parts by mass) of the ester wax W1 with respect to 100 parts by mass of crystalline vinyl resin.

M3 denotes a content rate (% by mass) of amorphous polyester resin in the binder resin.

S1 is an area ratio (%) of the amorphous phase with respect to the area of the crystalline phase.

Mw is a weight average molecular weight Mw of the crystalline vinyl resin.

TABLE 5-1

| | | Low-temperature | | Discharged paper | | Hot offset resistance | | Heat-resistant | |
|---|---|---|---|---|---|---|---|---|---|
| | | fixability | | sticking | | Fixing | | storability | |
| | | Fixing start | | Number | | temperature | | Degree of | |
| E. | T. | temperature | | of spots | | width | | agglomeration | |
| No. | No. | (° C.) | Rank | (pieces) | Rank | (° C.) | Rank | (%) | Rank |
| E.1 | 1 | 95 | A | 2 | A | 40 | A | 4.9 | A |
| E.2 | 2 | 100 | A | 2 | A | 40 | A | 5.5 | A |
| E.3 | 3 | 100 | A | 3 | A | 40 | A | 5.7 | A |
| E.4 | 4 | 95 | A | 2 | A | 40 | A | 5.5 | A |
| E.5 | 5 | 90 | A | 5 | B | 40 | A | 7.5 | A |
| E.6 | 6 | 90 | A | 21 | C | 40 | A | 16.4 | C |
| E.7 | 7 | 95 | A | 6 | B | 40 | A | 5.5 | A |
| E.8 | 8 | 95 | A | 25 | C | 40 | A | 3.9 | A |
| E.9 | 9 | 95 | A | 6 | B | 40 | A | 5.5 | A |
| E.10 | 10 | 95 | A | 2 | A | 40 | A | 5.0 | A |
| E.11 | 11 | 95 | A | 6 | B | 40 | A | 5.5 | A |
| E.12 | 12 | 95 | A | 3 | A | 40 | A | 5.0 | A |
| E.13 | 13 | 95 | A | 9 | B | 40 | A | 4.0 | A |
| E.14 | 14 | 95 | A | 5 | B | 40 | A | 4.2 | A |
| E.15 | 15 | 95 | A | 5 | B | 40 | A | 5.5 | A |
| E.16 | 16 | 90 | A | 6 | B | 40 | A | 7.6 | A |
| E.17 | 17 | 90 | A | 25 | C | 40 | A | 16.5 | C |
| E.18 | 18 | 95 | A | 6 | B | 40 | A | 5.6 | A |
| E.19 | 19 | 95 | A | 26 | C | 40 | A | 4.9 | A |
| E.20 | 20 | 95 | A | 6 | B | 40 | A | 7.6 | A |
| E.21 | 21 | 95 | A | 5 | B | 40 | A | 5.4 | A |
| E.22 | 22 | 95 | A | 6 | B | 40 | A | 7.3 | A |
| E.23 | 23 | 95 | A | 6 | B | 40 | A | 5.6 | A |
| E.24 | 24 | 95 | A | 13 | B | 40 | A | 5.1 | A |
| E.25 | 25 | 95 | A | 8 | B | 40 | A | 5.5 | A |
| E.26 | 26 | 95 | A | 7 | B | 40 | A | 7.6 | A |
| E.27 | 27 | 95 | A | 7 | B | 40 | A | 7.4 | A |
| E.28 | 28 | 90 | A | 8 | B | 40 | A | 8.5 | A |
| E.29 | 29 | 90 | A | 30 | C | 40 | A | 19.1 | C |
| E.30 | 30 | 95 | A | 9 | B | 40 | A | 3.5 | A |
| E.31 | 31 | 95 | A | 12 | B | 40 | A | 4.0 | A |
| E.32 | 32 | 120 | C | 21 | C | 60 | A | 4.1 | A |
| E.33 | 33 | 110 | B | 11 | B | 45 | A | 4.3 | A |
| E.34 | 34 | 90 | A | 2 | A | 25 | B | 7.5 | A |
| E.35 | 35 | 90 | A | 3 | A | 15 | C | 8.8 | A |

TABLE 5-2

| | | Low-temperature | | Discharged paper | | Hot offset resistance | | Heat-resistant | |
|---|---|---|---|---|---|---|---|---|---|
| | | fixability | | sticking | | Fixing | | storability | |
| | | Fixing start | | Number | | temperature | | Degree of | |
| E. | T. | temperature | | of spots | | width | | agglomeration | |
| No. | No. | (° C.) | Rank | (pieces) | Rank | (° C.) | Rank | (%) | Rank |
| E.36 | 36 | 90 | A | 3 | A | 10 | C | 9.8 | A |
| E.37 | 37 | 100 | A | 10 | B | 45 | A | 5.6 | A |
| E.38 | 38 | 95 | A | 4 | A | 45 | A | 5.3 | A |
| E.39 | 39 | 90 | A | 3 | A | 40 | A | 9.6 | A |
| E.40 | 40 | 90 | A | 2 | A | 40 | A | 12.7 | B |
| E.41 | 41 | 90 | A | 2 | A | 40 | A | 18.9 | C |
| E.42 | 42 | 95 | A | 9 | B | 45 | A | 4.4 | A |
| E.43 | 43 | 95 | A | 3 | A | 45 | A | 4.5 | A |
| E.44 | 44 | 95 | A | 2 | A | 45 | A | 5.2 | A |
| E.45 | 45 | 105 | B | 8 | B | 40 | A | 8.7 | A |
| E.46 | 46 | 110 | B | 22 | C | 40 | A | 9.7 | A |
| E.47 | 47 | 95 | A | 2 | A | 45 | A | 5.5 | A |
| E.48 | 48 | 95 | A | 6 | B | 40 | A | 6.7 | A |
| E.49 | 49 | 95 | A | 6 | B | 40 | A | 7.5 | A |
| E.50 | 50 | 95 | A | 4 | A | 40 | A | 6.4 | A |
| E.51 | 51 | 95 | A | 6 | B | 40 | A | 6.4 | A |
| E.52 | 52 | 95 | A | 22 | C | 40 | A | 6.4 | A |
| E.53 | 53 | 95 | A | 6 | B | 40 | A | 5.5 | A |
| E.54 | 54 | 95 | A | 2 | A | 40 | A | 4.4 | A |
| E.55 | 55 | 100 | A | 3 | A | 45 | A | 3.8 | A |
| E.56 | 56 | 105 | B | 2 | A | 50 | A | 3.5 | A |
| E.57 | 57 | 95 | A | 2 | A | 40 | A | 5.1 | A |
| E.58 | 58 | 95 | A | 4 | A | 40 | A | 5.5 | A |
| E.59 | 59 | 95 | A | 6 | B | 40 | A | 7.5 | A |
| E.60 | 60 | 95 | A | 14 | B | 10 | C | 8.9 | A |
| E.61 | 61 | 95 | A | 30 | C | 10 | C | 9.0 | A |
| E.62 | 62 | 95 | A | 15 | B | 10 | C | 9.5 | A |
| C.E.1 | C.1 | 100 | A | 51 | D | 55 | A | 5.2 | A |
| C.E.2 | C.2 | 100 | A | 41 | D | 15 | C | 4.8 | A |
| C.E.3 | C.3 | 100 | A | 42 | D | 50 | A | 4.5 | A |
| C.E.4 | C.4 | 95 | A | 6 | B | 50 | A | 22.9 | D |
| C.E.5 | C.5 | 95 | A | 9 | B | 10 | C | 23.1 | D |
| C.E.6 | C.6 | 95 | A | 45 | D | 15 | C | 17.1 | C |
| C.E.7 | C.7 | 95 | A | 9 | B | 10 | C | 22.2 | D |
| C.E.8 | C.8 | 95 | A | 42 | D | 15 | C | 16.9 | C |
| C.E.9 | C.9 | 95 | A | 26 | C | 10 | C | 22.9 | D |
| C.E.10 | C.10 | 100 | A | 53 | D | 15 | C | 7.5 | A |

In the Tables 5-1 and 5-2, “E.” represents “example”, “C.E.” represents “comparative example”, “C.” represents “comparison”, and “T.” represents “toner”

### Method of Evaluating Toner

### <1> Low-Temperature Fixability

A process cartridge filled with the toner was allowed to stand at 25° C. and a humidity of 40% RH for 48 hours. An unfixed image in an image pattern in which square images of 10 mm×10 mm were evenly arranged at 9 points over the entire transfer sheet was output with the use of LBP-712Ci modified so as to operate even with a fixing unit removed. The toner carrying amount on the transfer sheet was set to 0.60 mg/cm², and the fixing start temperature was evaluated. Note that as the transfer sheet, A4 paper (“Plover Bond Paper”: 105 g/m², manufactured by Fox River Paper Company) was used.

As the fixing unit, an external fixing unit obtained by removing the fixing unit of LBP-712Ci and allowing it to operate even outside the laser beam printer was used. Furthermore, the external fixing unit increases the fixation temperature by 5° C. from 90° C., and performs fixation under the condition of process speed: 300 mm/s.

The fixed image was visually checked, and with the lowest temperature at which no cold offset was caused as a fixing start temperature, the low-temperature fixability was evaluated. The evaluation results are shown in Tables 5-1 and 5-2.

### Evaluation Criteria

A: The fixing start temperature was equal to or less than 100° C.
B: The fixing start temperature was from 105° C. to 110° C.
C: The fixing start temperature was from 115° C. to 120° C.
D: The fixing start temperature was equal to or greater than 125° C.

### <2> Evaluation of Discharged Paper Sticking in Double-sided Printing Mode

The fixing start temperature obtained in the evaluation in <1> was set to a fixing temperature, and 200 copies of images of an image pattern in which square images of 10 mm×10 mm were evenly arranged at 9 points over the entire transfer sheets were output in a double-sided printing mode. The toner carrying amount of transfer sheets was set to 0.60 mg/cm², and setting was performed such that the printed square images were located at the same positions on the front surfaces and the rear surfaces. The bundle of sheets discharged from a sheet discharge portion was allowed to stand for 30 minutes or more in a stacked state and was then cooled to room temperature.

Thereafter, the images on the front and back sides of 50 sheets, which were 76th to 125th sheets in the bundle of sheets, were checked to evaluate image sticking depending on the numbers of white spots. Here, sticking in a case where the image pattern was successively printed was evaluated as evaluation of bonding between toners.

In a case where discharged paper sticking was able to be suppressed, the number of white spots in the printed images was small. On the other hand, in a case where it was not possible to suppress discharged paper sticking, white spots were generated when the bundle of sheets was peeled off due to adhesion between the toners, and the number of white spots thus increased.

### Evaluation Criteria

A: The number of white spots is less than five.
B: The number of white spots is equal to or greater than five and less than twenty.
C: The number of white spots is equal to or greater than twenty and less than forty.
D: The number of white spots is equal to or greater than forty.

### <3> Hot Offset Resistance

Under the same conditions as those in the evaluation of <1>, the highest temperature at which no hot offset was observed was regarded as the highest fixing temperature, and a difference between the highest fixing temperature and the fixing start temperature was regarded as a fixing temperature width. Evaluation criteria for the fixing temperature width were as follows.

### Evaluation Criteria

A: The fixing temperature width is equal to or greater than 40° C.
B: The fixing temperature width is equal to or greater than 25° C. and less than 40° C.
C: The fixing temperature width is equal to or greater than 10° C. and less than 25° C.
D: The fixing temperature width is less than 10° C.

### <4> Heat-Resistant Storability

In order to evaluate the stability during storage, the heat-resistant storability was evaluated. 5 g of toner was placed in a 100 mL resin cup and was left in an environment at a temperature of 50° C. and a humidity of 40 RH % for 10 days, and the degree of agglomeration of the toner was then measured as follows and was evaluated on the basis of the following criteria.

As a measurement apparatus, “Powder Tester” (manufactured by HOSOKAWA MICRON CORPORATION) was used in which a digital display vibrometer “DIGI-VIBRO MODEL 1332A” (manufactured by Showa Sokki Corporation) was connected to a side surface part of a vibration table of the Powder Tester. Furthermore, a sieve of 38 m in opening size (400 mesh), a sieve of 75 μm in opening size (200 mesh), and a sieve of 150 μm in opening size (100 mesh) were set to be stacked in order from the bottom on the vibration table of the Powder Tester. The measurement was performed in the following manner in an environment at 23° C. and 60% RH.
(1) The amplitude of the vibration table was adjusted in advance such that the displacement value of the digital display vibrometer was 0.60 mm (peak-to-peak).
(2) The toner left for 10 days as described above was allowed to stand for 24 hours in advance in an environment at 23° C. and 60% RH, and 5.00 g of toner was precisely weighed therefrom and was then gently placed on a sieve with an opening size of 150 μm in the uppermost stage.
(3) The sieve was vibrated for 15 seconds, the mass of the toner remaining on each sieve was then measured, and the degree of agglomeration was calculated on the basis of the following expression. The evaluation results are shown in Tables 5-1 and 5-2.

$$The degree of agglomeration ( \% ) = \{ ( the mass of the sample on the sieve with an opening size of 150 μm ( g ) ) / 5. ( g ) \} \times 100 + \{ ( the mass of the sample on the sieve with an opening size of 75 μm ( g ) ) / 5. ( g ) \} \times 100 \times 0.6 + \{ ( the mass of the sample on the sieve with an opening size of 38 μm ( g ) ) / 5. ( g ) \} \times 100 \times 0.2$$

### Evaluation Criteria

A: The degree of agglomeration is less than 10.0%.
B: The degree of agglomeration is equal to or greater than 10.0% and less than 15.0%.
C: The degree of agglomeration is equal to or greater than 15.0% and less than 20.0%.
D: The degree of agglomeration is equal to or greater than 20.0%.

According to the present disclosure, it is possible to provide a toner which suppresses discharged paper sticking in a high-speed printing process and exhibits excellent low-temperature fixability, hot offset resistance, and heat-resistant storability.

While the present disclosure has been described with reference to embodiments, it is to be understood that the present disclosure is not limited to the disclosed embodiments. The scope of the following claims is to be accorded the broadest interpretation so as to encompass all such modifications and equivalent structures and functions.

This application claims the benefit of Japanese Patent Application No. 2025-055068, filed Mar. 28, 2025, which is hereby incorporated by reference herein in its entirety.

What is claimed is:

1. A toner comprising a toner particle comprising a binder resin and an ester wax W1, wherein
the binder resin comprises
a crystalline vinyl resin having a monomer unit (a) represented by Formula (1) below, and
an amorphous vinyl resin, 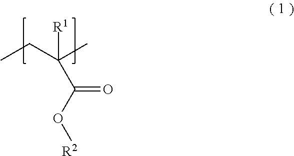
in Formula (1), R¹ represents a hydrogen atom or a methyl group, and R² represents a linear saturated alkyl group having 16 to 36 carbon atoms,
the ester wax W1 is at least one ester compound selected from the group consisting of Formulas (2-1) to (2-3) below, 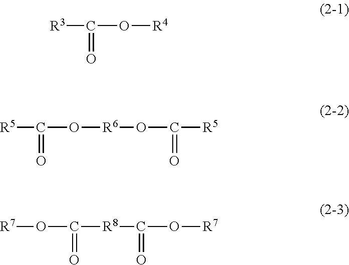
in Formula (2-1), R³ represents a linear saturated alkyl group having 13 to 29 carbon atoms, and R⁴ represents a linear saturated alkyl group having 14 to 30 carbon atoms,
in Formula (2-2), R⁵ each independently represents a linear saturated alkyl group having 13 to 29 carbon atoms, and R⁶ represents a linear saturated alkylene group having 16 or less carbon atoms,
in Formula (2-3), R⁷ each independently represents a linear saturated alkyl group having 14 to 30 carbon atoms, and R⁸ represents a linear saturated alkylene group having 14 or less carbon atoms,
when a cross section of the toner is observed by a scanning transmission electron microscope,
a phase separation structure having a crystalline phase comprising the crystalline vinyl resin as a main component and an amorphous phase comprising the amorphous vinyl resin as a main component is present in the cross section of the toner particle, and
domains containing the ester wax W1 as a main component are present in the amorphous phase.

2. The toner according to claim 1, wherein a content rate M1 of the crystalline vinyl resin in the binder resin is 5.0% by mass to 70.0% by mass.

3. The toner according to claim 1, wherein a content M2 of the ester wax W1 with respect to 100 parts by mass of the crystalline vinyl resin is 10.0 to 50.0 parts by mass.

4. The toner according to claim 1, wherein an area ratio S1 of the amorphous phase with respect to an area of the crystalline phase in the cross section of the toner particle is 20.0% to 100.0%.

5. The toner according to claim 1, wherein when a number average value of long diameters of the domains of the ester wax W1 that are present in the amorphous phase in the cross section of the toner particle is defined as d (nm), a value d/D of a ratio of d with respect to a number average particle diameter D (nm) of the toner satisfies Expression (3) below:
$$2.5 \times 1 {0}^{- 3} \leq d / D \leq 3.3 \times 1 {0}^{- 2} . \qquad ( 3 )$$

6. The toner according to claim 1, wherein any of conditions (i) to (iii) below is satisfied:
(i) the ester wax W1 comprises the ester compound represented by Formula (2-1),
and either an absolute value (|C_{R3}−C_{R2}|) of a difference between the number of carbon atoms comprised in R² and the number of carbon atoms comprised in R³ or an absolute value (|C_{R4}−C_{R2}|) of a difference between the number of carbon atoms comprised in R² and the number of carbon atoms comprised in R⁴ is equal to or less than four;
(ii) the ester wax W1 comprises the ester compound represented by Formula (2-2), and an absolute value (|C_{R5}−C_{R2}|) of a difference between the number of carbon atoms comprised in R² and the number of carbon atoms comprised in R⁵ is equal to or less than four; and
(iii) the ester wax W1 comprises the ester compound represented by Formula (2-3), and an absolute value (|C_{R7}−C_{R2}|) of a difference between the number of carbon atoms comprised in R² and the number of carbon atoms comprised in R⁷ is equal to or less than four.

7. The toner according to claim 1, wherein the amorphous vinyl resin has a monomer unit (b) represented by Formula (4) below: 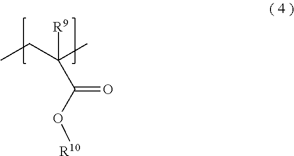
in Formula (4), R⁹ represents a hydrogen atom or a methyl group, and R¹⁰ represents a linear saturated alkyl group having 4 to 12 carbon atoms.

8. The toner according to claim 1, wherein
the binder resin further comprises an amorphous polyester resin, and
the amorphous polyester resin has a monomer unit (c) represented by Formula (5) below: 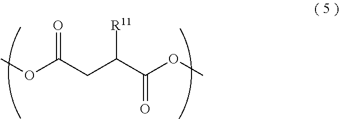
in Formula (5), R¹¹ represents an alkyl group or an alkenyl group having 8 to 16 carbon atoms.

9. The toner according to claim 8, wherein a content rate M3 of the amorphous polyester resin in the binder resin is 1.0% by mass to 15.0% by mass.

10. The toner according to claim 1, wherein
the toner particle further comprises an ester wax W2, and
the ester wax W2 is at least one ester compound selected from the group consisting of an ester compound of a tetrahydric to octahydric alcohol and an aliphatic monocarboxylic acid and an ester compound of a tetracarboxylic to octacarboxylic acid and an aliphatic monoalcohol.

11. The toner according to claim 10, wherein
the ester wax W1 comprises the ester compound represented by Formula (2-2),
the ester wax W2 is an ester compound of a tetrahydric to octahydric alcohol and an aliphatic monocarboxylic acid A2,
when a linear saturated alkyl group comprised in the aliphatic monocarboxylic acid A2 is defined as R¹², an absolute value (|C_{R5}−C_{R2}|) of a difference between the number of carbon atoms in R² and the number of carbon atoms in R⁵ is equal to or less than four,
an absolute value (|C_{R12}−C_{R2}|) of a difference between the number of carbon atoms in R² and the number of carbon atoms in R¹² is equal to or less than four, and
an absolute value (|C_{R12}−C_{R5}|) of a difference between the number of carbon atoms in R¹² and the number of carbon atoms in R⁵ is equal to or less than four.

12. The toner according to claim 1, wherein a number average particle diameter of the toner is 4.0 μm to 10.0 μm.

13. The toner according to claim 1, wherein in the observation of the cross section of the toner particle, a number nd of domains containing the ester wax W1 as a main component, which are present in the amorphous phase, per toner particle is 40.0 to 420.0.
